(19) United States
(12) Patent Application Publication
(10) Pub. No.: US 2010/0273677 A1
(43) Pub. Date: Oct. 28, 2010

(54) PROTEIN ANALYSIS

(75) Inventor: Fridtjof Lund-Johansen, Eiksmarka (NO)

Correspondence Address: YOUNG & THOMPSON, 209 Madison Street, Suite 500, Alexandria, VA, 22314, US

(73) Assignee: MEDINNOVA AS, Oslo (NO)

(21) Appl. No.: 12/809,879

(22) PCT Filed: Dec. 19, 2008
(86) PCT No.: PCT/EP08/11173

§ 371 Date: Jun. 21, 2010

(30) Foreign Application Priority Data
Dec. 21, 2007 (GB) 0725153.1

(51) Int. Cl. C40B 30/04; C40B 40/10; C40B 40/06

(52) U.S. Cl. 506/9; 506/18; 506/16

(57) ABSTRACT

A method of analysing the interaction between a mixture of molecular components and a group of binding agents includes the following steps. (i) Separating the molecular components in the mixture into a plurality of fractions on the basis of a physical parameter. (ii) Providing a plurality of different binding agents. (iii) Contacting the binding agents with at least two of the fractions and detecting the binding of the molecular components in each fraction to the binding agents. (iv) Detecting the presence of a plurality of the molecular components by the binding of the molecular components to the binding agents.

### FIELD OF THE INVENTION

The present invention relates to a method of analyzing the interaction between a mixture of molecular components and a group of binding or affinity agents. The invention also relates to a product for analyzing a mixture of molecular components and a bead comprising a particle that can be included in such a product.

### BACKGROUND ART

Resolving the complexity of biological systems requires analytical methods that can measure biopolymers at a large scale. To this end, multiplexed measurement of nucleotides with DNA microarrays has revolutionized analysis of gene expression by allowing parallel independent detection of all nucleotides present in a complex mixture. The principle is based on the design of a solid phase where a large number of defined nucleotides are bound at predefined locations. The nucleotides of the test sample are labeled and hybridized onto the solid support to allow each nucleotide in the sample to bind selectively to its mirror on the array. Several characteristics that are unique to nucleotides facilitate this type of large scale analysis. Interactions of nucleotides are predictable to the extent that capture probes with defined binding characteristics can be designed by computer algorithms and synthesized chemically. This allows specificity to be controlled at the capture level. The sample to be measured consists of a homogeneous set of molecules that are all present in a monomeric form. Labeling of the sample is controllable by using enzymes that attach the label to a predefined site of each molecule in the test sample. Finally, nucleotides are stable and do not deteriorate by the steps required for producing the array or during storage of the arrays.

In the post-genomic era, large-scale analysis of other bio-molecules, including proteins is now at the center of attention. Given that there are 23 000 protein coding genes in the human genome, the actual number of protein species is still not known. The vast majority of genes are organized in introns and exons that can be processed into more than one mRNA as a consequence of alternative splicing of the transcribed pre-mRNA. Hence, several protein species may be generated from one gene. DNA array experiments indicate that 74% of all human genes are alternatively spliced (1). Finally, proteins interact in multi-molecular complexes. The most comprehensive studies performed so far have revealed 2800 interactions, a number that clearly is grossly underestimated (2). Thus, the actual number of protein entities that must be measured for a comprehensive analysis of the proteome is overwhelming.

The success of DNA microarrays has spurred efforts to develop similar platforms for other bio-molecules. Several elements from DNA microarray technology have been adopted to produce affinity arrays for proteins (3-5). The affinity reagents commonly used in this format are pre-selected to bind a single target such as a defined protein or peptide. Most widely used are antibodies or recombinant proteins that have been developed by methods that involve selection against a defined structure such as a protein, a structural motif, phosphorylation site etc. Alternatively, capture probes are designed to mimic known binding motifs in biopolymers such as binding sequences for transcription factors and protein-protein-interaction domains such as SH2 domains and SH3 domains (6) (7). The latter exhibit a broader range of specificities, but have the advantage that they are direct mimics of biological interactions and therefore provide information of direct relevance for drug development. A third class of non-cognate affinity reagents is used in arrays for use with detection by mass spectrometry. Ciphergen Inc manufactures arrays that consist of a low number of matrices that each bind a wide variety of targets. Examples are ion exchange matrices and affinity matrices such as heparin. Mass spectrometry is used to discriminate the large number of targets that bind to each matrix.

The most successful application of affinity arrays this far is the multiplexing of traditional immune sandwich assays for cytokines (3). One antibody is attached to a solid phase and used to capture the analyte from a solution. A labeled antibody, reactive with a distinct site of the same cytokine, is used to detect the captured target on the solid phase. The sandwich format is an example of serial use of affinity reagents where a signal is measured only when both reagents bind simultaneously to the same target. A mixture of labeled detection antibodies can be used to detect multiple cytokines captured onto different sites of an array. Multiplexing is, however, limited by unacceptable background signal when the number of detection reagents in the mixture exceeds 20-40 (3). Attempts have been made to overcome the problem by using a devices where the detection reagents are spatially matched to location of the matched capture reagent (8, 9). This method is, however, difficult to set up and requires sophisticated instrumentation that is not generally available. Alternative approaches include production of multiple spatially separated arrays and probing each with a different set of detection reagents (10). Recently, Schallmeiner et al designed an assay where simultaneous binding of three different DNA-conjugated antibodies VEGF was measured. When the antibodies bound to the same target, the DNA-strands were close enough to be ligated by an enzyme (11). This method is elegant, and provides highly specific and sensitive measurement. Yet the multiplexing capacity is unknown and may be limited since molecules will come into proximity by chance as the number of reagents in the assay increases. A limitation with all systems based on detection with matched reagents is that the production and selection of suitable sandwich reagents is complicated.

Detection with protein labels is commonly used for large-scale analysis with affinity arrays (3, 12, 13). Prior to contact with the array, the sample is reacted with a dye or a hapten binding to reactive groups found in all the molecules to be analyzed, such as amines or thiols. The approach circumvents the need to develop matched reagents and can in principle be used to allow unlimited multiplexing. A number of products based on this platform are available from manufacturers such as Sigma Chemicals, Clontech, Ray Biosciences, Hypromatrix Inc and LabVision Inc.

Measurement using non-selective detection methods, such as protein-reactive dyes, is only useful when the number and nature of the captured species is known. Whereas no standard criteria exist, a reasonable minimal requirement in a screening setting is that at least 80% of the occupied binding sites bind the same target, For diagnostic purposes the specificity should be above 98%. An important question is therefore how often this selectivity is achieved. Antibodies often are referred to as mono-specific, but the term is only meaningful under certain conditions. For example, all antibodies must be titered to observe specificity as a band on a Western blot. The optimal titer varies considerably among reagents, and even optimally titered antibodies frequently stain more than one band on a blot. Michaud et al tested a handful of antibodies to yeast proteins against a proteome-wide array of yeast proteins and found that all had detectable cross-reactivity to defined proteins in addition to the intended cognate target (14). In some cases the signals measured from the cross-reactive proteins was higher than that of the cognate target. The use of antibodies in arrays is further complicated by the fact that the close proximity of binders on a solid substrate increases the avidity. The requirements for specificity under these conditions are likely to be higher than that needed when the antibodies are used as detection reagents. The difficulty in finding affinity reagents that are suitable for use in arrays is illustrated by the fact that Macbeath et al found that less than 5% of commercially available antibodies to intracellular targets were useful (4). Their criteria were for evaluating performance were, however, not disclosed. Haab et al found that 20% were useful when tested against a mixture of 115 target proteins (15). Even this success may be due to the fact that the test sample was far less complex than serum or cell lysates. For most antibodies, the term “mono-targeted” is more suitable since it implies that the reagent has been selected to target a single species, but that mono-specificity seldom is achieved.

Some key opinion leaders in the field of affinity arrays have claimed that affinity reagents that are mono-specific under a variety of conditions can be produced by optimizing methods for antibody production and selection (5, 16). Soderlind and co-authors report a method that allows production of highly specific recombinant antibodies to cytokines (17). Experiments where the cytokines were added to serum showed that a signal was only measured when the cytokine was added (18). Similar results were reportedly obtained with cell lysates (16). The authors have shown that arrays based on their reagents are useful to identify disease-specific patterns in cytokines (13) Even though the authors claim to have solved the specificity problem observed with other affinity reagents, the results disclosed so far are limited to detection of cytokines.

Most reagents used in commercially available affinity arrays have been tested for their ability to bind the intended target. Most often this testing involves capture from a biological sample such as a cell lysate, tissue extract or tissue culture supernatant. The ability to capture the intended target is then assessed by immune sandwich assays or by separation of the captured proteins on an SDS-PAGE and staining a western blot with an antibody to the intended target. This testing does, however, not address the question of whether the reagents cross-react with other species or bind different forms of the intended target. Results obtained with affinity arrays are therefore generally validated by assays where the binders are used to examine the sample by another method such as western blotting, immunohistochemistry or immune sandwich assays. Alternatively, differences in protein expression measured by protein affinity arrays have been compared to results obtained with DNA microarrays. These methods offer only indirect control of the performance of the reagents in the array. No information is obtained about the possibility that the reagent captures proteins other than the intended target. An alternative that is often used for anti-cytokine reagents, is to measure the amount of captured proteins before and supplementing a test sample with purified target. This method is, however, only useful for targets that can be obtained in purified forms that closely resemble their naturally occurring counterparts. Furthermore, the method is not applicable to targets that are ubiquitously expressed in cells or body fluids. Nor does it control for the possibility that the added or endogenous target is present in multiple forms for example in the context of protein complexes or breakdown products. Most cytokines interact with receptors with greater masses than the cytokine itself. Thus a constant amount of cytokine may produce different signals depending on its interaction with other molecules.

The total number of targets that are captured by an immobilized affinity reagent can be determined by eluting bound proteins from the complex and subjecting the proteins to an assay capable of detecting molecular heterogeneity without the bias of an affinity reagent. A well characterized example is the culture of cells in the presence of isotopes such as radioactive iodine that become incorporated in all proteins. After capture by the affinity reagent, the proteins are separated by SDS-polyacrylamide electrophoresis (SDS-PAGE). Alternatively, proteins can be labeled with chemically reactive detection probes prior to incubation with the immobilized affinity reagent or after separation in gels. These methods allow unbiased detection of all the major components captured by the affinity reagent.

Unbiased analysis of the total number of targets captured by immobilized binders has so far not been used in any published array.

Mass spectrometry can be used to identify proteins without the use of target-specific probes. So called SELDI technology (Ciphergen) has been applied to resolve different proteins captured by a single affinity reagent. Wang et al immobilized a nucleotide containing a transcription factor binding site to a SELDI array (19). A nuclear extract was contacted with the array, and four subunits of a bound protein complex were resolved by mass spectrometry. After prefractionation by ion-exchange, the purity of the captured proteins was sufficient to allow protease digestion and peptide mapping by MALDI-MS.

The method failed, however, to detect other AP-1 binding proteins that were demonstrated to be in the sample. Moreover, no attempts were made generalize the finding using other affinity reagents or to achieve multiplexing by immobilizing different affinity reagents to the array. Finally, the throughput of mass spectrometry is limited. Acquisition of data from an 8 well SELDI array takes 20 min with a standard instrument.

To summarize, the following problems can be seen to exist in developing validated arrays for large-scale analysis of non-nucleotide biopolymers:
1. Obtaining specificity through the use of target-specific detection reagents, results in unacceptable background in highly multiplexed systems. (3)
2. Detection with non-target selective methods such as protein labels does not resolve different molecules capable of binding to the same antibody.
3. Whereas mono-specific reagents have been made for cytokines, few affinity reagents that are available for other proteins have the same specificity. (4)
4. Cross-reactivity of affinity reagents is sample-dependent and difficult to predict. A reagent can therefore not be validated on the basis of a single sample, but must be tested under many different conditions.
5. Many multi-molecular complexes represent biologically relevant functional units. It is therefore desirable to measure these complexes in their intact state.
6. Many proteins occur in multi-molecular complexes, the composition of which may vary with cell type and activation status. Thus, even mono-specific affinity reagents may capture multiple targets.
7. Many of the best known affinity reagents (e.g. several antibodies to CD markers) bind conformation-dependent epitopes. Dissociation of multi-molecular complexes requires harsh conditions that often lead to loss of conformation-dependent epitopes.
8. Producing affinity reagents that react with a given complex, but not with the components in their free form or in other contexts is a daunting task.
9. Detection with methods that resolve multiple proteins bound to the same affinity reagent have low throughput.

Previously disclosed methods and products for multiplexed analysis of proteins have failed to provide a satisfactory solution to problems 1 to 9, listed above. Satisfactory performance of affinity reagents under conditions suited for large-scale analysis, has in practice only been achieved for a few dozen specificities, mainly cytokines, for which excellent sandwich assays have been available for years. Prior art techniques are further limited to studying proteins that occur in monomeric forms or as complexes composed of a single species. No technology exists for large-scale analysis of protein complexes or alternatively spliced forms of proteins. The present invention therefore seeks to alleviate one or more of the above problems.

### SUMMARY OF THE INVENTION

The instant invention addresses at least some of problems 1 to 9 by introducing a novel parameter in multiplexed assays with mono-targeted affinity reagents. One or more sample pre-fractionation steps are used to separate biopolymers or other molecular components with defined characteristics into separate fractions. Each fraction is then analyzed independently with antibody arrays.

Parallel analysis of multiple sample fractions provides a matrix that can be used to identify the overlap in specificities of two or more affinity reagents to the same target. This approach to multiplexed analysis provides information about overlapping specificity of antibodies or other affinity reagents used in parallel on a solid phase. The power of the approach may be increased by increasing the number of affinity reagents to each target and increasing the complexity of fractionation. Moreover, in some embodiments there are provided arrays with two or more affinity reagents for each target.

As mentioned above, unbiased detection of all proteins captured by an affinity reagent will frequently provide complex data. In a western blot the binding pattern is predictable from the size of the intended target. Discriminating capture of an intended target in multiple forms from non-specific capture is far more complex. Furthermore, as pointed out by key opinion leaders in the field of affinity arrays, sample prefractionation often reduces sensitivity and compromises reproducibility. Two innovative features of embodiments of the present invention overcome these problems. First, arrays are designed with multiple antibodies to each target. This design provides an internal reference for each reagent. This is a significant advantage when the distribution of the intended target cannot be predicted. For example, a given antibody may bind its intended target in two different complexes and cross-react with another protein. Another antibody to the intended target should bind the two complexes, but is unlikely to cross-react with the same protein as the first antibody. Second, an innovative use of computer algorithms designed for analysis of DNA microarray data was made. These programs are generally used to cluster large data samples and combined with programs that visualize data in the form of color-maps. Our data show that traditional cluster analysis is suitable to detect reagents with similar specificity. Yet, many other useful reagents were identified by aligning results from different antibodies next to each other. Patterns of overlaps that were not detected by the cluster algorithms, were readily visualized. Thus, the data disclosed herein show rather surprisingly that when antibody array analysis is combined with protein fractionation, the specificity of the assay can be enhanced by increasing the number of capture reagents used to detect each target even when the binders show considerable cross-reactivity. This provides a simple solution to problem 4 above. This is because, when considering different antibodies to a target, the overlap in specificity to the target is more consistent than the overlap of cross-reactivities. The power of this reference increases with increasing number of fractions and antibodies used to detect each target.

Embodiments of the instant invention apply sample pre-fractionation to measure different biopolymers or other molecular components that bind to the same affinity reagent independently. These embodiments rely on the principle of using the overlap in the specificity of two different antibodies (or other affinity reagents) selected for the same target to obtain higher target specificity than that which is obtained using the reagents individually. To exploit this principle without using target-specific reagents for detection, samples are divided into multiple fractions which contain different proteins both qualitatively and quantitatively. Multiple fractions are analyzed in parallel with an array where two or more antibodies to the target of interest are bound at distinct predefined positions or on different solid phases. The results disclosed herein show that parallel analysis of multiple fractions obtained by size exclusion chromatography provides a reference matrix that can be used to detect overlapping specificity of antibodies by computer algorithms such as cluster analysis. It is highly surprising that a single fractionation method with limited resolution results in such a remarkable specificity control. Fractionation has been used in the prior art to enrich samples for nuclear proteins (21), phosphorylated proteins (22) and small proteins (23) prior to hybridization with antibody arrays. However, since only the enriched fraction was measured, the results provide little information about the specificity of the affinity reagents. In fact, key opinion leaders in the field of antibody arrays have recently stated that fractionation compromises yield and reproducibility (5).

Pre-fractionation of samples provides additional information that cannot be obtained by measurement of unfractionated samples. For example, fractionation may be used to resolve functionally different forms of a protein, sub-cellular localization or functionally distinct complexes of a given protein. The results disclosed herein show that these functionally important parameters are useful criteria to discriminate the intended target of an affinity reagent from a target with which the affinity reagent is cross-reactive.

An important advantage of fractionated analysis is that internal control of specificity circumvents the requirement for mono-specific affinity reagents. This is advantageous since few available affinity reagents are mono-specific for any target. Thus in some embodiments, there is provided a product that overcomes the requirement for mono-specific capture reagents. This device comprises two or more affinity reagents selective, but not mono-specific, for a common target. The reactivity pattern to a series of sample fractions is then compared. The overlapping specificity is detected as the overlap in reactivity towards the sample fractions.

The results disclosed herein are an example of large-scale identification of endogenous multi-molecular complexes. The results demonstrate a new type of immune sandwich assay where pairs of antibodies are immobilized to different sites on a solid phase or on different particles and their overlap in specificity is assessed by comparing their reactivity towards a series of sample fractions. Further embodiments comprise arrays with two or more antibodies to each target, the antibodies being selected such that they share reactivity patterns in a large number of samples.

According to one aspect of the present invention, there is provided a method of analysing the interaction between a mixture of molecular components and a group of binding agents comprising the steps of:
(i) separating the molecular components in the mixture into a plurality of fractions on the basis of a physical parameter or location;
(ii) providing a plurality of different binding agents,
(iii) contacting the binding agents with at least two of the fractions and detecting the binding of the molecular components to the binding agents in at least two of the fractions; and
(iv) detecting the presence of a plurality of the molecular components by the binding of the molecular components to the binding agents.

According to another aspect of the present invention, there is provided a method of analysing a mixture of molecular components comprising the steps of:
(i) separating the molecular components in the mixture into a plurality of fractions on the basis of a physical parameter and contacting each fraction with a plurality of reporter molecules;
(ii) providing a plurality of different binding agents,
(iii) contacting the binding agents with at least two of the fractions and detecting the binding of the reporter molecules to the binding agents in at least two of the fractions; and
(iv) detecting the presence of a plurality of the molecular components by the binding of the reporter molecules to the binding agents.

Conveniently, wherein the reporter molecules are polypeptides susceptible to enzymatic modification.

According to a further aspect of the present invention, there is provided a method of analysing the interaction between a mixture of molecular components and a group of binding agents comprising the steps of:
(i) producing an enriched fraction of molecular components possessing a combination of two or more physical parameters shared by less than 5% of the molecular components in the mixture
(ii) selecting a plurality of different binding agents having specificity for molecular components having the physical parameters.
(iii) contacting the binding agents with the enriched fraction of molecular components and detecting the binding of the molecular components in the enriched fraction to the binding agents; and
(iv) detecting the presence of a plurality of the molecular components by the binding of the molecular components to the binding agents.

Preferably, the binding agents are immobilised on one or more solid substrates.

Advantageously, the binding agents are immobilised in an array on the surface of one planar substrate or a planar substrate comprising three-dimensional surface structures.

Alternatively, the binding agents are immobilised on a plurality of particles, each particle having immobilised thereon binding agents specific for the same target molecules.

Conveniently, the particles having binding agents specific for one type of target molecule have a different detectable feature from the particles having binding agents specific for another type of target molecule.

Preferably, the detectable feature is fluorescence, size, acoustic properties, charge or magnetic properties.

Advantageously, each particle has at least one type of dye molecule bound to it, preferably at least three types of dye molecules bound to it.

Conveniently, the or each dye molecule is selected from the following dye molecules: a dye molecule having an absorption maximum of 405 nm and an emission maximum of 420-450 nm; a dye molecule having an absorption maximum of 405 nm and an emission maximum of greater than 500 nm; a dye molecule having an absorption maximum of 488 nm and an emission maximum of 520-530 nm; and a dye molecule having an absorption maximum of 632 nm and an emission maximum of 650-670 nm.

Preferably, the or each molecule is selected from Alexa 488, Alexa 647, Pacific Blue and Pacific Orange.

Advantageously, step (iii) comprises the step of using a flow cytometer.

Conveniently, the binding agents are immobilised on the substrate via affinity coupling.

Preferably, the affinity coupling is via protein G, protein A, protein L, streptavidin, antibodies or fragments thereof.

Advantageously, step (iii) is carried out in a medium which comprises a non-functional binding agent, preferably in a concentration of at least 100 times greater than the concentration of binding agents released from the particles during a 24 h incubation period at 4° C.

Conveniently, the non-functional binding agent is non-immune IgG.

Preferably, step (i) comprises separating the molecular components in the mixture into at least three fractions, preferably between 3 and 100 fractions, more preferably between 3 and 50 fractions, more preferably between 10 and 30 fractions.

Conveniently, step (i) comprises separation or enrichment of molecular components in the mixture by: sub-cellular fractionation of a cell lysate; differential mass separation; charge separation; hydrophobicity separation; or binding of molecular components to different affinity ligands.

Conveniently, step (i) is carried out by size exclusion chromatography, SDS PAGE elution, dialysis, filtration, ion exchange separation, or isoelectric focussing.

Preferably, the binding agents comprise antibodies or antigen-binding fragments thereof, affibodies, polypeptides, peptides, oligonucleotides, T-cell receptors, or MHC molecules

Advantageously, the method further comprises attaching at least one label to a plurality of molecular components in the mixture or to the reporter molecules.

Conveniently, the step of attaching the label or labels to the molecular components or reporter molecules is carried out prior to step (i).

Alternatively, the step of attaching the label for labels to the plurality of molecular components or reporter molecules is carried out after step (i).

Alternatively, the step of attaching the label for labels to the plurality of molecular components is carried out after step (iii).

Preferably, a different label is attached to the molecular components or reporter molecules of each fraction.

Advantageously, the label is attached to the plurality of molecular components or reporter molecules via a chemically reactive group.

Conveniently, the label is attached to the plurality of molecular components or reporter molecules via, a peptide, a polypeptide, an oligonucleotide, or an enzyme substrate,

Preferably, the method further comprises carrying out steps (i), (ii) and (iii) in respect of a second mixture of molecular components and further comprising the step of attaching a further label or labels to a plurality of the molecular components of the second mixture of molecular components.

Conveniently, the or each label comprises a hapten, fluorescent or luminescent dye or a radioactive or non-radioactive isotope.

Alternatively, the binding between a binding agent and a molecular component or receptor molecule is detected by a label free system, preferably, surface plasmon resonance or magnetic resonance.

Preferably, the binding agents form sets, each set of binding agents being capable of binding the same target molecule; the binding agents of at least two sets being capable of binding different target molecules.

Advantageously, there are at least three sets of binding agents whose binding agents are capable of binding different target molecules.

Conveniently, at least two binding agents in each set are preselected to bind to the same target molecule.

Preferably, at least 40 of the binding agents are capable of binding at least one, preferably at least two, other target molecule in a prokaryotic or eukaryotic cell lysate in addition to the target molecule, directly or indirectly, in an aqueous buffered solution having a pH between 4 and 8.

Advantageously, at least two of the fractions are contacted with an overlapping repertoire of binding agents.

Alternatively, at least two of the fractions are contacted with a different repertoire of binding agents.

Conveniently, the method further comprises the step of, prior to step (iii), enriching the mixture or a fraction of the mixture with one species of molecular component.

Preferably, the step of enriching the mixture or fraction comprises: contacting the mixture or fraction with an affinity reagent capable of binding to the species of molecular component; selectively removing the species of molecular component from at least some other components in the mixture or fraction; and releasing the affinity reagent from the species of molecular component.

Advantageously, the species of molecular component is a protein complex.

Conveniently, the method further comprises the step of separating the protein complex into its constituent proteins after the enriching step and prior to step (iii).

Preferably, the method further comprises the step of:
(v) analysing at least some of the molecular components or reporter molecules that have been bound to the binding agents using mass spectrometry.

Advantageously, the molecular components comprise proteins.

According to another aspect of the invention, there is provided a method of analysing the binding specificity of a plurality of binding agents comprising carrying out the method of analysing the interaction between a mixture of molecular components in accordance with the invention wherein step (i) comprises separating the molecular components in the mixture into at least three fractions on the basis of the physical parameter and comparing the binding of the binding agents with respect to at least three of the fractions.

According to a further aspect of the invention, there is provided a product for analysing a mixture of molecular components wherein the product comprises a plurality of sets of binding agents having the same degree of binding specificity as an antibody, said binding agents having been selected based on their selectivity and capacity for binding molecular components in a sample by means of a protocol comprising the steps of:
(i) separating the molecular components of a biological sample into a plurality of fractions on the basis of a physical parameter or location;
(ii) providing a plurality of different binding agents;
(iii) contacting the binding agents with at least two of the fractions and detecting the binding of the molecular components to the binding agents in at least two of the fractions;
(iv) selecting binding agents where each selected binding agent has a specificity for one molecular component in a fraction of above 80% as measured by a uniform distribution of signal measured across a series of continuous fractions and a binding affinity for said specific molecular component of less than 1 μM under specified binding conditions, wherein the specified binding conditions are in an aqueous buffered solution having a pH of between 4 and 8 and wherein the binding agent is immobilised to a solid substrate under the specified binding conditions.

According to yet another aspect of the present invention, there is provided a product for analysing a mixture of molecular components wherein the product comprises: means for producing an enriched fraction of the mixture on the basis of a physical parameter or location of molecular components in the fraction; and a plurality of binding agents, having the same degree of binding specificity as antibodies, and wherein the binding agents have a specificity for one molecular component in the fraction above 80% under specified binding conditions, wherein the specified binding conditions are in an aqueous buffered solution having a pH of between 4 and 8 and wherein the binding agent is immobilised to a solid substrate under the specified binding conditions.

Conveniently, the biological sample is selected from blood and blood products including plasma, serum and blood cells; bone marrow, mucus, lymph, ascites fluid, spinal fluid, biliary fluid, saliva, urine, extracts from brain, nerves and neural tracts, muscle, heart, liver, kidney, bladder and urinary tracts, spleen, pancreas, gastric tissue, bowel, biliary tissue, skin, thyroid gland, parathyroid gland, salivary glands, adrenal glands, mammary glands, gastric and intestinal mucosa, lymphatic tissue, mammary glands, adipose tissue, adrenal tissue, ovaries, uterus, blood and lymphatic vessels, endothelium, lung and respiratory tracts, prostate, testes, bone, lysates from cells originating from said organs, and lysates from bacteria, and yeast,

Preferably, the binding agents are immobilised on one or more solid substrates.

Advantageously, the binding agents are immobilised in an array on the surface of one planar substrate or a planar substrate comprising three-dimensional surface structures.

Conveniently, the solid substrates are a plurality of particles, each particle having immobilised thereon binding agents specific for the same target molecules.

Preferably, the particles having binding agents specific for one molecular component have a different detectable feature from the particles having binding agents specific for another molecular component.

Advantageously, the detectable feature is fluorescence, size, acoustic properties, charge or magnetic properties.

Conveniently, each particle has at least one type of dye molecule bound to it, preferably at least three types of dye molecules bound to it.

Preferably, the or each dye molecule is selected from the following dye molecules: a dye molecule having an absorption maximum of 405 nm and an emission maximum of 420-450 nm; a dye molecule having an absorption maximum of 405 nm and an emission maximum of greater than 500 nm; a dye molecule having an absorption maximum of 488 nm and an emission maximum of 520-530 nm; and a dye molecule having an absorption maximum of 632 nm and an emission maximum of 650-670 nm.

Advantageously, the or each molecule is selected from Alexa 488, Alexa 647, Pacific Blue and Pacific Orange.

Conveniently, the binding agents are immobilised on the substrate via affinity coupling.

Preferably, the affinity coupling is via protein G, protein A, protein L, streptavidin, binding agents for affinity tags, or nucleotides.

Advantageously, the binding agents comprise antibodies or antigen-binding fragments thereof, affibodies, peptides, DNA or RNA fragments, T-cell receptors or MHC molecules.

Conveniently, the product comprises at least 40 sets of binding agents whose binding agents are capable of binding different molecular components.

Preferably, the binding agents have a binding affinity of less than 100 nm under the specified binding conditions.

Advantageously, at least 40 sets of the binding agents are capable of binding between 2 and 20 target molecules in a biological sample under the specified binding conditions.

According to a further aspect of the present invention, there is provided a bead comprising a particle having at least three different dye molecules covalently attached thereto, the dye molecules being selected from at least three of the following dye molecules:
(i) a dye molecule having an absorption maximum of 405 nm and an emission maximum of 420-450 nm;
(ii) a dye molecule having an absorption maximum of 405 nm and an emission maximum of greater than 500 nm;
(iii) a dye molecule having an absorption maximum of 488 nm and an emission maximum of 520-530 nm; and
(iv) a dye molecule having an absorption maximum of 632 nm and an emission maximum of 650-670 nm.

Conveniently, the dye molecules are selected from Alexa 488, Alexa 647, Pacific Blue and Pacific Orange.

Preferably, the bead comprises four of the defined dye molecules.

Advantageously, the three different dye molecules are covalently attached to the particle in different concentrations.

According to another aspect of the present invention, there is provided a set of beads, each bead in the set being in accordance with the invention and wherein at least two of the beads in the set have different concentrations of at least one of the covalently attached dye molecules.

Conveniently, each particle has four different dye molecules covalently attached to it and wherein, across the set of beads, there are at least four different concentrations of two of the dye molecules on the surface of the particles; at least three different concentrations of one of the dye molecules on the surface of the particles and at least two different concentrations of the other dye molecule on the surface of the particles.

In this specification, the term “physical parameter” means a measurable feature of a component per se and is independent of the location of the component.

### BRIEF DESCRIPTION OF THE FIGURES

FIG. 1 is a diagram of a bead in accordance with one embodiment of the present invention.

FIG. 2 is a diagram of a detection product in accordance with another embodiment of the present invention.

FIG. 3 is a schematic diagram of a method in accordance with another embodiment of the present invention.

FIG. 4 shows graphically particle counts of dyed particles following flow cytometry.

FIG. 5 is a schematic diagram of the results of carrying out a method in accordance with a further embodiment of the present invention.

FIG. 6 is a color-map showing the results of analysis of 16 fractions of a sample by 12 sets of beads.

FIG. 7 is a color-map comparing the binding of fractions from two different cell lysate samples to identical sets of beads.

FIG. 8 is a color-map comparing the binding of fractions from two similar cell lysate samples to identical sets of beads.

FIG. 9 is a color-map comparing the binding of different sub-cellular fractions and fractions of different cell lysate samples to identical sets of beads.

FIG. 10 is a color-map showing the binding of fractions of a sample to beads with rows clustered according to binding pattern. Two enlarged sections of the color-map are also shown.

FIG. 11 is a schematic diagram of the method of another embodiment of the present invention.

FIG. 12 is a color map showing the binding of fractions from samples enriched for two different proteins to identical sets of beads.

### DETAILED DESCRIPTION

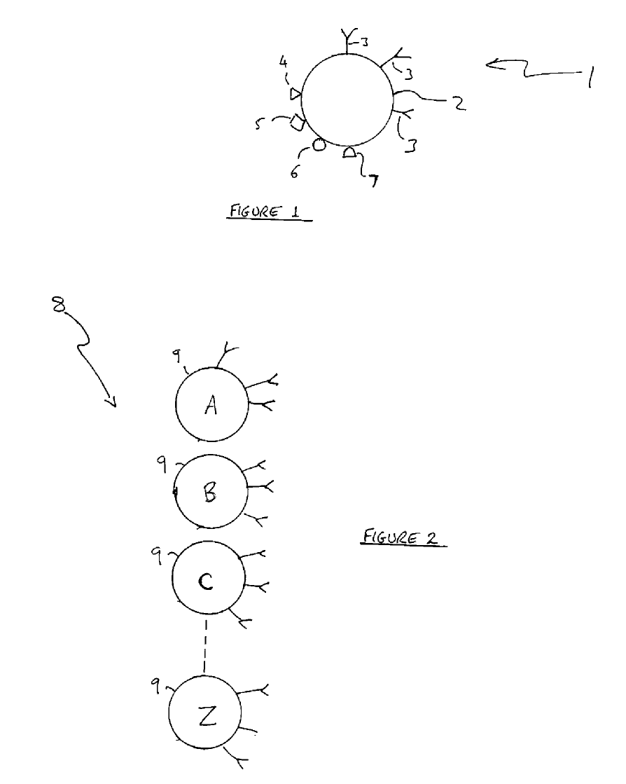

Referring to FIG. 1, one embodiment of the present invention will now be described. A bead 1 comprises a substantially spherical particle 2. On the surface of the particle are located a plurality of immobilised antibodies 3. The antibodies are attached to the surface of the particle 2 via a protein G affinity coupling. The antibodies 3 are all specific for the same target molecule although it is to be noted that, in practice, antibodies are not entirely mono-specific and it is to be expected that an antibody will typically bind between 1 and 20 different targets in a prokaryotic or eukaryotic cell lysate under physiological conditions. Also covalently attached to the surface of the particle 2, or trapped within it, are first to fourth types of dye molecules 4-7. The first type of dye molecule 4 is Alexa 488, the second type of dye molecule 5 is Alexa 647, the third type of dye molecule 6 is Pacific Blue, and the fourth type of dye molecule 7 is Pacific Orange. The dye molecules are all available from Invitrogen, USA.

Referring, now, to FIG. 2, a detection product 8 comprises a plurality of beads 9. Each of the beads 9 is the same as the bead 1 shown in FIG. 1 except in two respects. Firstly, the concentration of each type of dye molecule attached to the surface of each particle is different. Thus the bead marked “A” has a different and distinguishable relative concentration of dye molecules from the bead marked “B”. Secondly, the specificity of the antibodies 3 attached to each of the beads 9 is different and so the antibodies 3 of the bead marked “A” will bind different targets from the antibodies of the bead marked “B”. It is also to be understood that, while only one bead 9 of each type is shown in FIG. 2, the product 8 comprises multiple identical beads 9 of each type. Thus each individual bead 9 shown in FIG. 2 represents a set of identical beads.

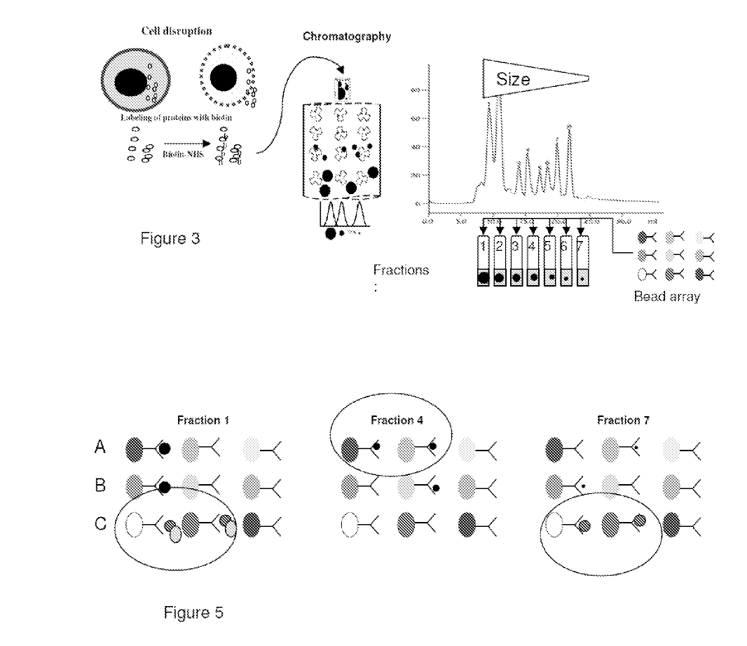

The product 8 is used in order to analyse a sample of molecular components such as a cell lysate as will now be described with reference to FIG. 3. Optionally, the sample is processed in order to enrich the sample for a specific type of molecular component. For example, the sample may be enriched for molecular components having a particular range of molecular weights or may be enriched by passing the sample through an affinity column specific for proteins with a narrow range of binding characteristics. If the sample is enriched for protein complexes, the complexes may be reduced to their constituent components prior to further processing of the sample.

Subsequently, the molecular components in the sample are each marked with an identical label such as a fluorescent or luminescent dye or a radioactive isotope by attaching the label to each component via biotin-streptavidin linkage. The marked sample is liquefied as necessary and is then subjected to size exclusion chromatography (SEC) in order to separate the sample into 7 fractions, each fraction comprising molecular components having a different molecular weight. The beads of the detection product 8 are separated into 7 equal portions. One portion is mixed thoroughly with the first of the sample fractions under the specified conditions (i.e. an aqueous buffered solution having a pH in the range of 4 to 9) and in the presence of non-functional antibody. The non-functional antibody is, for example, non-immune IgG and is present in a concentration 100 times higher than the concentration of antibodies released from the particles during the incubation period 2 at 4° C. Thus the antibodies 3 on the beads 1 bind to any molecular components in the fraction that they are capable of binding. Furthermore, if any of the antibodies 3 become detached from their respective particles, it is very unlikely for them to become attached to a bead from another set as the high concentration of the non-functional antibodies in the mixture tends to result in the attachment of any antibodies to particles being non-functional antibodies. In this way, errors in the detection of antibodies associated with the beads are avoided.

The beads are then extracted from the sample by centrifugation and washed with buffers. In some embodiments, the label itself is not detectable, but serves as a binding site for a detectable probe. For example, a hapten may be used to label the sample, in which case the particles are detectably labelled with fluorescently conjugated anti-hapten-probes such as phycoerythrin-labeled streptavidin. The beads are finally analysed using a flow cytometer. More specifically, the flow cytometer examines each bead and detects the presence or absence of the label attached to any bound molecular component as well as the relative concentrations, of the dye molecules 4-7 attached to the bead 1. The relative concentration of the dye molecules 4-7 indicates the set from which the bead 1 comes and the presence of the label indicates that the antibodies of the bead are capable of binding to a molecular component. The results of the examination of each bead are then compiled to indicate the number of beads in each set that were found to bind a molecular component.

The process is then repeated by mixing a second portion of the detection product 8 with the second of the sample fractions; analysing using the flow cytometer; and compiling the results and then mixing a third portion with the third of the sample fractions and so on until all of the 7 sample fractions have been analysed. The results for all fractions are then displayed side-by-side for each set of beads, thus giving an indication of the relative degree of binding of each set of beads for each fraction of the sample. In this embodiment, the results are displayed by way of a color map such that the color used is indicative of the amount of sample protein associated with the beads in each set.

Since antibodies are not generally mono-specific in their binding, it is to be appreciated that each set of antibodies generally binds more than one molecular component from non-overlapping fractions. For example, if the antibodies were generated against a first target having a molecular weight of 45 kD then the set of beads that has the antibodies will be seen to bind a target in the fraction containing components having a molecular weight of 45 kD. However, if the antibody also binds a complex comprising the first target and the complex has a molecular weight of 105 kD then the set of beads will also be seen to bind a molecular component in the fraction containing components having a molecular weight of 105 kD. Thus, for a given detection product, a particular sample of molecular components generates a specific binding pattern. Moreover, the presence of a particular binding pattern for a sample being tested is indicative of the presence of a particular molecular component within the sample. Accordingly, the capacity of antibodies to bind more than one target is used to the advantage of the present invention and it is preferred that there are at least 40 sets of beads that are capable of binding more than one target molecule (ideally between 2 and 20 target molecules) in a prokaryotic or eukaryotic cell lysate under physiological or near physiological conditions. After the analysis of the sample by flow cytometry, a particular molecular component may be isolated by incubating a fraction enriched for the target with particles with a single specificity. The molecular components bound to the beads may be detached from the beads and analysed by incubating the released protein with an affinity array. Alternatively, other techniques may be used. For example, if a molecular component is a protein, it may be trypsinised and subjected to mass spectroscopy in order to determine the amino acid sequence of the protein.

In the above described embodiment, a bead in each set is identified by the concentration of each of the dye molecules on the surface of the particles. In one particular embodiment, across the set of beads, there are four different concentration variants of the dyes Alexa 488 and Alexa 647, three different concentration variants of the dye Pacific Blue and two different concentration variants of the dye Pacific Orange. This yields a total of 300 sets of beads that can be individually identified.

In the above-described embodiment, the antibodies 3 are displayed on particles 2. Unlike slides or membranes, particles can be processed in microwell plates and are therefore well suited for high throughput sample processing. This is a significant advantage for the analysis of highly fractionated samples. In the prior art, particle-based systems have offered a low degree of multiplexing. This drawback has limited the utility of particle-based arrays for large-scale analysis (Kingsmore). Embodiments of the present invention overcome this limitation by using highly multiplexed particle arrays labeled with four colors for coding rather than two. In other embodiments, a different set of dyes may be used and more than or fewer than four different dyes (e.g. three different dye molecules) may be used.

Previously disclosed results have shown that when dyes with overlaps in absorption and emission spectra are used to label the same particle, fluorescence from one dye is absorbed by another. Thus the number of different dyes whose emission can be measured from a particle is limited by fluorescence resonance energy transfer between the dyes on the particles (see Brinkey & Haugland U.S. Pat. No. 5,326,692 and Chandler et al U.S. Pat. No. 6,514,295). An unexpected observation made during development of the instant invention was that available absorption and emission spectra were poor predictors for successful dye combinations. Thus, the dye Pacific Blue has considerable overlap with the excitation spectrum of Alexa-488. Yet, particles having high levels of Alexa 488 exhibited little loss in Pacific Blue fluorescence. In contrast, Alexa-750 which has minimal spectral overlap with Pacific Orange, quenched the latter almost completely. Surprisingly, the sequence of labeling was also critical to obtain the desired resolution. It was necessary to label first with the dyes that were least affected by others to allow independent detection of these. These dyes were Alexa-488 and Alexa 647. Resolution of Pacific Blue and Pacific Orange was obtained by measuring these dyes for particles with a given level of Alexa 488 and Alexa-647. In alternative embodiments, four different dye molecules are used which have the following set of absorption and emission spectra: Dye 1: Absorption max (A-max) 405 nm, Excitation max (E-max) 420-450 nm, Dye 2: A-max 405 nm E-max >500 nm, Dye 3: A-max 488 nm, E-max 520-530 nm, Dye 4: A-max 632 nm, E-max 650-670 nm.

A number of different techniques for attaching dye molecules to particles exist. In some embodiments, the technique disclosed in U.S. Pat. No. 6,514,295 (which is incorporated herein by reference) is used. In summary, the technique provides microparticles dyed with multiple combinations of two fluorophores. The principle of this technique is based on a technique disclosed by Bangs et al (L. B. Bangs (Uniform Latex J Particles; Seragen Diagnostics Inc. 1984, p. 40, which is incorporated herein by reference) where a polymer particle is suspended in an organic solvent. The technique consists of adding an oil-soluble or hydrophobic dye to stirred microparticles and after incubation washing off the dye. The microspheres used in this method are hydrophobic by nature. The particles are swelled in a hydrophobic solvent which also contains hydrophobic fluorescent dyes. Once swollen, such particles absorb dyes present in the solvent mixture in a manner analogous to water absorption by a sponge. The level and extent of swelling is controlled by incubation time, the quantity of cross-linking agent preventing particle from disintegration, and the nature and amount of solvent(s). By varying these parameters a dye is diffused throughout a particle or fluorescent dye-containing layers or spherical zones of desired size and shape are obtained. Removing the solvent terminates the staining process. Microparticles stained in this manner will not “bleed” the dye in aqueous solutions or in the presence of water-based solvents or surfactants such as anionic, nonionic, cationic, amphoteric, and zwitterionic surfactants.

The problem with this technique is that it requires the labeling to be performed in one step since repeated swelling of the particles in organic solvents may lead to leakage of the dyes added in the previous step. This is a significant limitation when a large number of dyes are used in combination. Therefore, in preferred embodiments, each dye is added sequentially and leakage is prevented by covalent attachment of the dyes to the particles. Further details of the attachment of dyes to particles is provided in WO2007/008084 which is incorporated herein by reference.

In further embodiments, the beads are not identified by the relative concentration of dye molecules on their surfaces but are instead identified by the fluorescence, size, acoustic properties, charge or magnetic properties of the beads or components attached to the beads.

In the above described embodiment, the sample is separated into 7 different fractions but in other embodiments the sample is separated into a greater or lower number of fractions. Generally the number of fractions is between 10 and 20 fractions, but the number of fractions can be between 3 and 50 or even 3 and 100.

It is also to be understood that, while in the above-described embodiment, the sample is fractionated on the basis of size exclusion chromatography, the present invention may involve a wide range of types of fractionation. Fractionation on the basis of the following physical parameters may, for example, be used: differential mass separation; charge separation; hydrophobicity separation; or binding of molecular components to different affinity ligands. In order to fractionate, the following techniques may be used in other embodiments: SDS PAGE elution, dialysis, filtration, ion exchange separation, or isoelectric focussing. Size exclusion chromatography is used to separate native proteins and is widely used as a first dimension in identification of multi-molecular complexes. Due to the low resolution of size exclusion chromatography, the method is commonly combined with a second separation method. Most frequently used is SDS-PAGE, which separates denatured proteins by their size (20). Surprisingly, the data disclosed herein show that size exclusion chromatography alone is sufficient for high resolution analysis of protein complexes with antibody array analysis (see Examples 1 to 4).

In some alternative embodiments, sub-cellular fractionation of a cell lysate is used to separate a sample into fractions. Sub-cellular fractionation is used to obtain information about the distribution of molecules in different cellular compartments. Membrane proteins have hydrophobic domains and remain associated with lipids when a cell is disrupted in the absence of detergents or in the presence of low levels of detergents. Other cell compartments that can be isolated include the nucleus, organelles and the cytoplasm. Thus, a cell extract with non-overlapping content of many proteins can be obtained by a relatively simple fractionation into a limited number of fractions. The data disclosed herein show that sub-cellular fractionation is a highly useful matrix for detecting proteins.

The observed reproducibility and utility of fractionation of the present invention is particularly surprising in view of a recent review by key opinion leaders in the field who state that fractionation invariably leads to lower yield and poor reproducibility (18). In striking contrast to this view, the disclosed data show that the reactivity patterns of antibodies against multiple sample fractions are in fact so reproducible that they group antibodies to the same targets in cluster analysis (see Examples 6 and 7).

The embodiment described above involves beads which display antibodies in order to bind targets. That is to say, the binding agents or affinity reagents (the terms are used interchangeably in this specification) are antibodies. However, in alternative embodiments, only a fragment of an antibody is used, such as an Fab of F(ab′)₂ fragment or even the complementarity determining regions of an antibody arranged in an artificial structure to maintain the binding specificity of the antibody from which they are obtained. In other embodiments, an altogether different binding agent is used. The following are exemplary binding agents used in other embodiments: affibodies, peptides, DNA or RNA fragments, T-cell receptors or MHC molecules. What is significant, however, is that the binding agent must have the same degree of binding specificity as an antibody. Thus in one embodiment a binding agent that binds between 2 and 20 target molecules in a prokaryotic or eukaryotic cell lysate would be a suitable binding agent but a binding agent that binds over 100 target molecules in such a cell lysate would not be a suitable binding agent. In addition, the binding agents useful in the present invention generally have a binding affinity for their target of less than 1 μM under physiological conditions, preferably less than 100 nM.

In the above-described embodiment, the molecular components in the sample are labelled prior to fractionation of the sample. However, in alternative embodiments, the sample is fractionated prior to labelling and, moreover, the molecular components of each fraction are labelled with a different label. In these embodiments, the labelled fractions are then re-combined and are analysed simultaneously by flow cytometry. The flow cytometer examines the label of the molecular components attached to each bead in order to determine the fraction from which the molecular component comes and thus it is possible to generate more quickly the same information as in the first embodiment.

In a related alternative embodiment, two separate samples may be analysed substantially simultaneously by labelling each sample with a different label prior to mixing the samples, fractionating the mixed samples and analysing by flow cytometry. It is possible to distinguish between the binding of molecular components from each sample by the label attached to the molecular components. This technique is useful for analysing the interaction between molecular components of two separate samples as complexes of molecular components from each sample can be detected since they display both labels.

It is also to be noted that in some further embodiments, a detectable label is not attached to the molecular components in the sample. Instead, the binding of a molecular component to the antibody (or other binding agent) is detected by a label-free system such as plasmon or magnetic resonance whereby the increased mass or charge of the bead on which the antibody is located is detected and is indicative of a molecular component binding the antibody.

As has been explained above, each set of beads in the detection product 8 displays antibodies 3 (or another binding agent) that bind a different target. In preferred embodiments, the beads in each set are not identical and instead the set comprises sub-sets of beads. Each sub-set of beads is distinguishable by the relative concentration of the dye molecules attached to it and displays antibodies that bind the same target but at a different epitope. Typically, the use of such a detection product to analyse a sample results in the same results for each of the sub-sets. However, if the target forms a complex which obscures the epitope to which one set of antibodies binds then that sub-set of beads will not bind to the complex. This technique is particularly useful when combined with size fractionation because protein complexes are distinguishable from their individual components on the basis of size. For example, if two sub-sets are provided in a detection product, each specific for different epitopes of a protein that forms a complex and one of the epitopes is obscured when the complex is formed, the binding pattern of the sample will show both sub-sets binding the protein in a low molecular weight fraction but only one of the sub-sets binding the complex in a high molecular weight fraction. Thus the presence and size of the protein complex can be detected by such an embodiment. It is particularly preferred that there are at least three sub-sets (capable of binding a target at different epitopes) in each set.

In some alternative embodiments, each fraction of the sample is contacted with a different set of beads, the sets of beads displaying antibodies selected to be suitable for binding the fraction. For example, in one embodiment, the sample is fractionated on the basis of the size of the molecular components and then each fraction is contacted with sets of beads displaying antibodies capable of binding targets having a molecular weight in the range of molecular weights corresponding to the fraction.

In the embodiments described above, the antibodies (or other binding agents) are attached to particles which are analysed by flow cytometry. However, it is to be understood that the invention is not limited to such embodiments. For example, in one alternative embodiment, no particles are provided. Instead, the antibodies 3 are immobilised on the surface of a planar substrate. The substrate may alternatively, have raised (i.e. three-dimensional) structures on its surface in some embodiments. The antibodies 3 are arranged in the form of an array of spots, each spot comprising antibodies with identical specificity. Unlike the previous embodiments, no dye molecules are provided because the identity of the antibodies on the array is indicated by their location on the array. In use, the sample is labelled and fractionated as in the previous embodiments and then the array is contacted with the first fraction from the sample. Unbound sample is then washed from the array and the array is then examined at each spot to determine whether any labelled molecular components are bound at the spot and, if so, how much label is present. Once each spot is analysed, the results are compiled in a similar manner to that described in the previous embodiments. A second array is then provided which is contacted with the second fraction of the sample and the process is repeated until all of the sample fractions have been analysed.

In another alternative embodiment of the present invention, a sample is analysed as follows. The sample is separated into fractions by passing the sample through an affinity column comprising heparin. The flow-through is passed through a column of anion-exchange resins. The bound molecular components are then released from the heparin and anion-exchange resin columns to produce first and second fractions, respectively. A first detection product is provided which comprises beads displaying antibodies generated to bind molecular components that bind heparin and the first detection product is contacted with the first fraction and is analysed by flow cytometry as described above. A second detection product is provided which comprises beads displaying antibodies generated to bind molecular components that are bound by anion-exchange resins. The second detection product is contacted with the second fraction and the mixture is analysed by flow cytometry as described above. This embodiment provides a rapid technique for analysing samples which is particularly useful in medical diagnostics.

The invention has been described thus far in relation to the analysis of samples of molecular components. However, it is to be appreciated that in other embodiments of the present invention, binding agents such as antibodies are analysed. For example, in one embodiment, the binding specificity of three antibodies is determined by generating a standard protein mixture (for example, a lysate of a particular cell line), separating the mixture into twenty fractions by SEC and comparing the binding pattern of beads displaying each type of antibody. It can then be seen whether the antibodies bind targets in only one fraction (which indicates that they are relatively specific) or whether the antibodies bind targets in multiple fractions, indicating that the antibodies are relatively non-specific.

In a further embodiment, the principle of combining sample fractionation and antibody array analysis is extended to a method for high throughput identification of the components of multi-molecular complexes. A fraction containing a protein complex is identified by antibody array analysis. The fraction is prepared and a single additional purification step is carried out. This is followed by analysis of the purified fraction with arrays displaying antibodies specific for candidate components of the complex. This allows immediate identification of known interaction partners of a specific protein such as the adaptor protein slp-76. This embodiment is particularly advantageous since characterization of multi-molecular complexes by prior art methods requires a series of complex fractionation steps.

In the above described embodiments of the invention, the antibodies, or other binding agents, bind directly to the molecular components and in this way the interaction between the antibodies and the molecular components is analysed. More specifically, the presence of the molecular components in the mixture can be detected by the binding of the antibodies directly to the molecular components. However, in alternative embodiments, after the step of fractionating the mixture, each fraction is contacted with a plurality of reporter molecules. The reporter molecules are enzymatic substrates which are susceptible to modification by certain molecular components in the mixture which are enzymes. Thus, following mixing of the reporter molecules with the molecular components of the mixture, the reporter molecules are modified by the enzymes in the mixture, thereby adding or removing epitopes on the reporter molecules. Subsequently, each fraction of molecular components is contacted with antibodies that are capable of binding to the reporter molecules either with or without the enzymatic modification and the binding interactions between the antibodies and the reporter molecules are detected as described above.

For example, in one particular embodiment, a cell lysate is fractionated by SEC into seven fractions and each fraction is contacted with a plurality of reporter polypeptides which have sites susceptible to phosphorylation. The reporter polypeptides are mixed with the molecular components of each fraction and fractions containing protein kinases specific for the reporter polypeptides phosphorylate the reporter molecules. A plurality of sets of antibodies are then added to each fraction. Each set of antibodies comprises antibodies that are specific for the phosphorylated reporter polypeptides but are not capable of binding the unphosphorylated reporter polypeptides. The binding of each set of antibodies to the reporter polypeptides is then detected as is described in relation to previous embodiments. Where such binding is not detected in a fraction, it is indicative of the absence of an active protein kinase from the original cell lysate of the size corresponding to that fraction. Where such binding is detected in a fraction, it is indicative of the presence of an active protein kinase in the original cell lysate of the size corresponding to that fraction.

In alternative variants of these embodiments, the enzyme whose presence may be detected is a phosphatase, protease, lipase etc. rather than a kinase. It is also to be understood that in some embodiments, the antibodies are specific for reporter molecules which are unmodified but are not capable of binding modified reporter molecules. In these embodiments, the detection of binding of the antibodies to reporter molecules in a fraction is indicative of the absence of the enzyme, for which the reporter molecules are sensitive, from the fraction.

In certain embodiments of the invention, kits comprising antibodies or other binding agents are provided. In one embodiment, a kit is provided in which the antibodies have been selected for their suitability for binding the molecular components in a particular cell lysate. This is achieved by fractionating the cell lysate by SEC into ten fractions, contacting each fraction with a plurality of different antibodies and selecting those antibodies for which 80% of the antibodies bind one specific target in a fraction under physiological conditions, when immobilised on a solid substrate.

In a further embodiment, a kit is provided which comprises means for producing an enriched fraction of a cell lysate such as one or more chromatographic resins in e.g. a microwell filter plate (1 um pore size available from Millipore Inc) or disposable or reusable columns. The kit also comprises antibodies that have been selected, as described in the previous embodiment, such that 80% of the antibodies in the kit bind one specific target in the fraction with a selectivity of 80% or more.

In carrying out the invention, reference may also be made to Wu W., et al. Antibody array analysis with label-based detection and resolution of protein size. Mol. Cell Proteomics 2008 Sep. 16, which is incorporated herein by reference.

### EXAMPLES

### Materials and Methods

Covalent coupling of protein G and fluorescent dyes to particles: Polymer particles (6 or 8 um, PMMA, amine-functionalized, www.Bangslabs.com) were reacted with sulfo-SPDP (Sigma) (3 mg per gram of particles) at 10% solids in PBS 1 mM EDTA 1% Tween 20 (PBT) for 30 min at 22° C. under constant rotation. The particles were pelleted by centrifugation at 500 g for 5 min, washed once in PBT, and reduced with 5 mM TCEP (Sigma) for 20 min at 37° C. Particles were pelleted, washed once in 100 mM MES pH5 (MES-5) and resuspended at 10% solids in MES-5. Protein G (Fitzgerald Industries) was dissolved at 5 mg/ml in PBS, reacted with 100 ug/ml Sulfo-SMCC (30 min, 22° C.) and transferred to MES-5 using G-50 spin columns. Two milligrams of protein G-SMCC was added per gram of particles under constant vortexing. After 30 min of rotation at 22° C., particles were resuspended in 100 mM MES pH6 containing 1 mM EDTA 1% Tween 20 with 1 mM TCEP (MES-6-TCEP) and stored at 4° C. until labeling with fluorescent dyes. Particles were stable for several weeks in this buffer. Fluorescent labeling was performed by incubating equal aliquots of particles at 1% solids with a serially diluted fluorescent maleimide for 30 min at 22° C. Differently labeled aliquots were washed with twice in MES-6-TCEP and split in new aliquots, each of which were reacted with different concentrations of the next dye. The sequence used here was Alexa 488, Alexa 647, Pacific blue (all in MES-6) and Pacific Orange (PBT). The starting concentrations were 50 ng/ml for Alexa 488 and Alexa 647 25 ng/ml for Pacific Blue and 500 ng/ml for Pacific Orange. The dilutions were between two and three-fold.

Binding of antibodies to color-coded particles: Before coupling of antibodies, particles were suspended in PBS casein block buffer (www.piercenet.com) for 24 h at 4° C. Polyclonal antibodies (2 ug for 10 ul of 10% bead suspension) were added to particles suspended in casein-PBS block buffer. The particles were rotated for 30 min at 22° C. For binding of mouse monoclonal antibodies, particles were first reacted with subclass-specific goat-anti-mouse IgG Fc (Jackson Immunoresearch), then with the mAbs. After three washes in PBT, a small aliquot of all particles was added to a single vial and labeled with phycoerythrin (PE) conjugated anti-mouse, anti-rabbit and anti-goat IgG to assess antibody binding. The particles were resuspended in PBT with 50% trehalose and 40 ug/ml non-immune gamma globulins from goat and mouse to prevent crossover of specific antibodies between particles. Particles with different antibodies were mixed and stored frozen in aliquots at −70° C. Control experiments showed that freezing did not affect performance of the arrays (not shown). Approximately 5% of the particle populations were coupled to polyclonal non-immune immunoglobulins mouse and goat IgG and used as reference for background.

Cells: Human leukocytes were obtained from buffy coats from healthy blood donors. Mononuclear cells were isolated by gradient centrifugation (Lymphoprep, GE Biosciences). The cell lines K562 (bcr-abl pos CML), Jurkat (T-ALL), NB4 (AML-M3), ML2 (AML-M4), 3T3 (fibroblasts) and HeLa (ovarian carcinoma) were cultured in RPMI with 20 mM HEPES and 5% fetal bovine serum.

Antibodies: The antibodies used are listed in Table 1, gamma-globulins from mouse, rabbit and goat, and streptavidin Phycoerythrin (PE) were from Jackson Immunoresearch. (www.JiREurope.com).

Cell lysis: Cytoplasmic lysates were prepared by incubating cells on ice in, 20 mM HEPES and 1 mM MgCl2 for 15 min followed by a freeze-thaw step. Nuclei and membranes were pelleted by centrifugation at 500 g for 2 min, washed twice in the hypotonic buffer. lysed with PBS with 1% lauryl maltoside. Lysates were cleared by centrifugation and stored at −70° C.

TABLE 1

| Number | Antibody | Source | Ig type |
|---|---|---|---|
| 1 | 14.3.3, Pan_Ab-4 | Labvision | mouse IgG1 |
| 2 | abl ab1 | Labvision | mouse IgG1 |
| 3 | Caspase9_Ab-3 | Labvision | mouse IgG1 |
| 4 | CD3zeta_ab-8 | Labvision | mouse IgG1 |
| 5 | CDC14Aphosphatase_Ab-1 | Labvision | mouse IgG1 |
| 6 | CDC25B_Ab-3 | Labvision | mouse IgG1 |
| 7 | CDC25C_Ab-1 | Labvision | mouse IgG1 |
| 8 | CDC25C_Ab-7 | Labvision | mouse IgG1 |
| 9 | CDC47_Ab-2 | Labvision | mouse IgG1 |
| 10 | CDC6_Ab-1 | Labvision | mouse IgG1 |
| 11 | CDC7k_Ab-1 | Labvision | mouse IgG1 |
| 12 | Cdh1_Ab-1 | Labvision | mouse IgG1 |
| 13 | cdk4_Ab-1 | Labvision | mouse IgG1 |
| 14 | cdk4_Ab-2 | Labvision | mouse IgG1 |
| 15 | cdk5_Ab-2 | Labvision | mouse IgG1 |
| 16 | cdk5_Ab-3 | Labvision | mouse IgG1 |
| 17 | cdk6_Ab-1 | Labvision | mouse IgG1 |
| 18 | cdk6_Ab-2 | Labvision | mouse IgG1 |
| 19 | empty | | mouse IgG1 |
| 20 | Chk2_Ab-7 | Labvision | mouse IgG1 |
| 21 | cyclin A_Ab-6 | Labvision | mouse IgG1 |
| 22 | cyclin B1_ab-1 | Labvision | mouse IgG1 |
| 23 | cyclin B1_Ab-3 | Labvision | mouse IgG1 |
| 24 | cyclin D3_ab-1 | Labvision | mouse IgG1 |
| 25 | cyclin D3_Ab-2 | Labvision | mouse IgG1 |
| 26 | cyclin E_Ab-2 | Labvision | mouse IgG1 |
| 27 | ltk/Emt/Tsk_Ab-1 | Labvision | mouse IgG1 |
| 28 | Ki67_Ab-5 | Labvision | mouse IgG1 |
| 29 | mitochondria p60_ab-2 | Labvision | mouse IgG1 |
| 30 | RBL1 p107_Ab-2 | Labvision | mouse IgG1 |
| 31 | RbL1 p107_Ab-1 | Labvision | mouse IgG1 |
| 32 | rbl2130_Ab-1 | Labvision | mouse IgG1 |
| 33 | rbl2 p130_Ab-2 | Labvision | mouse IgG1 |
| 34 | p130cas_Ab-1 | Labvision | mouse IgG1 |
| 35 | p14ARF_Ab-2 | Labvision | mouse IgG1 |
| 36 | p14ARF_Ab-3 | Labvision | mouse IgG1 |
| 37 | p15ink4b_ab-6 | Labvision | mouse IgG1 |
| 38 | empty | | |
| 39 | APC11_Ab-1 | Labvision | rabbit |
| 40 | APC2_Ab-1 | Labvision | rabbit |
| 41 | CDK1 CDC2_p34 | Labvision | rabbit |
| 42 | CDC25B_Ab-4 | Labvision | rabbit |
| 43 | CDC34_Ab-1 | Labvision | rabbit |
| 44 | CDC37_Ab-1 | Labvision | rabbit |
| 45 | cdk1_Ab-4 | Labvision | rabbit |
| 46 | cdk3_Ab-1 | Labvision | rabbit |
| 47 | cdk4_Ab-5 | Labvision | rabbit |
| 48 | p53 (SP5) | Labvision | rabbit |
| 49 | CDK5_Ab-5 | Labvision | rabbit |
| 50 | cdk8_Ab-1 | Labvision | rabbit |
| 51 | Cullin-1_Ab-1 | Labvision | rabbit |
| 52 | Cullin-1_Ab-2 | Labvision | rabbit |
| 53 | Cullin-2_Ab-1 | Labvision | rabbit |
| 54 | Cullin-2_Ab-2 | Labvision | rabbit |
| 55 | Cullin-2 | Labvision | rabbit |
| 56 | Cullin-3_Ab-1 | Labvision | rabbit |
| 57 | empty | | rabbit |
| 58 | cyclin A_Ab-7 | Labvision | rabbit |
| 59 | cyclin B1_Ab-2 | Labvision | rabbit |
| 60 | cyclin B1 | Labvision | rabbit |
| 61 | cyclin C_Ab-1 | Labvision | rabbit |
| 62 | cyclin D1_Ab-4 | Labvision | rabbit |
| 63 | cyclin D1_Ab-3 | Labvision | rabbit |
| 64 | cyclin D1 | Labvision | rabbit |
| 65 | cyclin E_Ab-1 | Labvision | rabbit |
| 66 | cyclin E2_Ab-1 | Labvision | rabbit |
| 67 | Gab-1_Ab-1 | Labvision | rabbit |
| 68 | JAB1 | Labvision | rabbit |
| 69 | KAP | Labvision | rabbit |
| 70 | Ki67_Ab-4 | Labvision | rabbit |
| 71 | Ki-67 | Labvision | rabbit |
| 72 | NCK_Ab-1 | Labvision | rabbit |
| 73 | p14ARF | Labvision | rabbit |
| 74 | p14ARF_Ab-1 | Labvision | rabbit |
| 75 | p14ARF_Ab-4 | Labvision | rabbit |
| 76 | empty | | |
| 77 | CD4_m241 | Horejsi | mouse IgG1 |
| 78 | CD4_m242 | Horejsi | mouse IgG1 |
| 79 | CD8_m87 | Horejsi | mouse IgG1 |
| 80 | CD8_m146 | Horejsi | mouse IgG1 |
| 81 | CD11A m83 | Horejsi | mouse IgG1 |
| 82 | cd222 m238 | Horejsi | mouse IgG1 |
| 83 | CD11am95 | Horejsi | mouse IgG1 |
| 84 | lck | Horejsi | mouse IgG1 |
| 85 | cd11a m144 | Horejsi | mouse IgG1 |
| 86 | CD43 m256 | Horejsi | mouse IgG1 |
| 87 | mHCI m155 | Horejsi | mouse IgG1 |
| 88 | mHCI m147 | Horejsi | mouse IgG1 |
| 89 | CD43_m59 | Horejsi | mouse IgG1 |
| 90 | CD5_m247 | Horejsi | mouse IgG1 |
| 91 | CD11b m170 | Horejsi | mouse IgG1 |
| 92 | CD43 m257 | Horejsi | mouse IgG1 |
| 93 | CD31 m05 | Horejsi | mouse IgG1 |
| 94 | CD147 m6/7 | Horejsi | mouse IgG1 |
| 95 | empty | | |
| 96 | cyclin B1_Ab-4 | Labvision | mouse IgG2a |
| 97 | cyclin D1_Ab-1 | Labvision | mouse IgG2a |
| 98 | cyclin D1_Ab-2 | Labvision | mouse IgG2a |
| 99 | cyclin D2_Ab-2 | Labvision | mouse IgG2a |
| 100 | cyclin E_Ab-5 | Labvision | mouse IgG2a |
| 101 | E2F-1_Ab-6 | Labvision | mouse IgG2a |
| 102 | JAK3_Ab-1 | Labvision | mouse IgG2a |
| 103 | p16ink4a_Ab-7 | Labvision | mouse IgG2a |
| 104 | p21WAF1_Ab-3 | Labvision | mouse IgG2a |
| 105 | p53_Ab-3 | Labvision | mouse IgG2a |
| 106 | p53_Ab-6 | Labvision | mouse IgG2a |
| 107 | p63_Ab-2 | Labvision | mouse IgG2a |
| 108 | p63_Ab-4 | Labvision | mouse IgG2a |
| 109 | PCNA_Ab-1 | Labvision | mouse IgG2a |
| 110 | CDC25A_Ab-3 | Labvision | mouse IgG2a |
| 111 | Chk2_Ab-5 | Labvision | mouse IgG2a |
| 112 | bcl-X_Ab-1 | Labvision | mouse IgG2a |
| 113 | cdk1_Ab-1 | Labvision | mouse IgG2a |
| 114 | empty | | |
| 115 | B2m-02 | Horejsi | mouse IgG1 |
| 116 | CD45 m28 | Horejsi | mouse IgG1 |
| 117 | cd71 m189 | Horejsi | mouse IgG1 |
| 118 | CD41 m06 | Horejsi | mouse IgG1 |
| 119 | mHCII m136 | Horejsi | mouse IgG1 |
| 120 | CD147 m6/1 | Horejsi | mouse IgG1 |
| 121 | CD44_m263 | Horejsi | mouse IgG1 |
| 122 | CD54 m112 | Horejsi | mouse IgG1 |
| 123 | CD45RA m93 | Horejsi | mouse IgG1 |
| 124 | CD29 m101A | Horejsi | mouse IgG1 |
| 125 | CSK-04 | Horejsi | mouse IgG1 |
| 126 | CD147 m6/8 | Horejsi | mouse IgG1 |
| 127 | cbl_sc1631 | Santa Cruz | mouse IgG1 |
| 128 | zap70_sc32760 | Santa Cruz | mouse IgG1 |
| 129 | FYN_sc434 | Santa Cruz | mouse IgG1 |
| 130 | YES_sc8403 | Santa Cruz | mouse IgG1 |
| 131 | VAV_sc8039 | Santa Cruz | mouse IgG1 |
| 132 | CD3z_sc1239 | Santa Cruz | mouse IgG1 |
| 133 | empty | | |
| 134 | cdk2_Ab-1 | Labvision | mouse IgG2b |
| 135 | Chk1_Ab-1 | Labvision | mouse IgG2b |
| 136 | cdk7/CAK_Ab-1 | Labvision | mouse IgG2b |
| 137 | cyclin D1(SP4) | Labvision | mouse IgG2b |
| 138 | cyclin D2_Ab-3 | Labvision | mouse IgG2b |
| 139 | cyclin G_Ab-1 | Labvision | mouse IgG2b |
| 140 | Lck_Ab-1 | Labvision | mouse IgG2b |
| 141 | p21WAF1_Ab-11 | Labvision | mouse IgG2b |
| 142 | p53_Ab-4 | Labvision | mouse IgG2b |
| 143 | p53_Ab-5 | Labvision | mouse IgG2b |
| 144 | p57kip2_Ab-6 | Labvision | mouse IgG2b |
| 145 | p57kip2_Ab-3 | Labvision | mouse IgG2b |
| 146 | cdk2_Ab-4 | Labvision | mouse IgG2b |
| 147 | cyclin D2_Ab-4 | Labvision | mouse IgG2b |
| 148 | p53_Ab-8 | Labvision | mouse IgG2b |
| 149 | empty | | |
| 150 | CHK2_Ab-1 | Labvision | mouse IgG1 |
| 151 | unknown | | mouse IgG2b |
| 152 | empty | | |
| 153 | p15INK4b_Ab-2 | Labvision | rabbit |
| 154 | p16INK4a_Ab-3 | Labvision | rabbit |
| 155 | p18ink4c_Ab-1 | Labvision | rabbit |
| 156 | p19 skp1_Ab-1 | Labvision | rabbit |
| 157 | p27kip1 | Labvision | rabbit |
| 158 | p53 | Labvision | rabbit |
| 159 | p73_Ab-5 | Labvision | rabbit |
| 160 | PCNA | Labvision | rabbit |
| 161 | Raf1_Ab-1 | Labvision | rabbit |
| 162 | ROC1_Ab-1 | Labvision | rabbit |
| 163 | ROC1 | Labvision | rabbit |
| 164 | Stat6_Ab-1 | Labvision | rabbit |
| 165 | Lck(p56)_Ab-2 | Labvision | rabbit |
| 166 | bcl-2a_Ab-1 | Labvision | mouse IgG1 |
| 167 | F2 | | |
| 168 | HSP90 sc (aasheim) | Santa Cruz | |
| 169 | HSC70_sc7928 | Santa Cruz | |
| 170 | PI3K p110_sc8010 | Santa Cruz | mouse IgG2a |
| 171 | empty | | |
| 172 | p16ink4a_Ab-1 | Labvision | mouse IgG1 |
| 173 | p16ink4a_Ab-4 | Labvision | mouse IgG1 |
| 174 | p16ink4a_Ab-6 | Labvision | mouse IgG1 |
| 175 | p18ink4c_Ab-3 | Labvision | mouse IgG1 |
| 176 | p19 ink4d_Ab-1 | Labvision | mouse IgG1 |
| 177 | p16ink4a_Ab-2 | Labvision | mouse IgG1 |
| 178 | p21WAF1_Ab-5 | Labvision | mouse IgG1 |
| 179 | p21WAF1_Ab-6 | Labvision | mouse IgG1 |
| 180 | p27kip1_Ab-1 | Labvision | mouse IgG1 |
| 181 | p35nck5a_Ab-1 | Labvision | mouse IgG1 |
| 182 | p53_Ab-2 | Labvision | mouse IgG1 |
| 183 | p53_Ab-1 | Labvision | mouse IgG1 |
| 184 | CDk4_Ab-6 | Labvision | mouse IgG1 |
| 185 | Cdk5_Ab-4 | Labvision | mouse IgG1 |
| 186 | Cdk6_Ab-3 | Labvision | mouse IgG1 |
| 187 | p73_Ab-4 | Labvision | mouse IgG1 |
| 188 | p73_Ab-1 | Labvision | mouse IgG1 |
| 189 | p73_Ab-2 | Labvision | mouse IgG1 |
| 190 | empty | | |
| 191 | SPP1_sdi | Strategic Diagnostic Inc. | rabbit |
| 192 | CD22_sdi | Strategic Diagnostic Inc. | rabbit |
| 193 | CDH5_sdi | Strategic Diagnostic Inc. | rabbit |
| 194 | EGFR_sdi | Strategic Diagnostic Inc. | rabbit |
| 195 | p14 Arf/CDKN2A_sdi | Strategic Diagnostic Inc. | rabbit |
| 196 | PSEN2_sdi | Strategic Diagnostic Inc. | rabbit |
| 197 | CD66e CEACAm5_sdi | Strategic Diagnostic Inc. | rabbit |
| 198 | cyclin D1 CCND1_sdi | Strategic Diagnostic Inc. | rabbit |
| 199 | mTA1_sdi | Strategic Diagnostic Inc. | rabbit |
| 200 | Ki67_sdi | Strategic Diagnostic Inc. | rabbit |
| 201 | mmP11_sdi | Strategic Diagnostic Inc. | rabbit |
| 202 | NSF_sdi | Strategic Diagnostic Inc. | rabbit |
| 203 | INSR_sdi | Strategic Diagnostic Inc. | rabbit |
| 204 | empty | | rabbit |
| 205 | INSR_sdi | Strategic Diagnostic Inc. | rabbit |
| 206 | IL4R_sdi | Strategic Diagnostic Inc. | rabbit |
| 207 | IL4R_sdi | Strategic Diagnostic Inc. | rabbit |
| 208 | ADRB2_sdi | Strategic Diagnostic Inc. | rabbit |
| 209 | GCGR_sdi | Strategic Diagnostic Inc. | rabbit |
| 210 | CD22_sdi | Strategic Diagnostic Inc. | rabbit |
| 211 | CCR5_sdi | Strategic Diagnostic Inc. | rabbit |
| 212 | IL2_sdi | Strategic Diagnostic Inc. | rabbit |
| 213 | INS_sdi | Strategic Diagnostic Inc. | rabbit |
| 214 | BRCA1_sdi | Strategic Diagnostic Inc. | rabbit |
| 215 | CD66a CEACAm1_sdi | Strategic Diagnostic Inc. | rabbit |
| 216 | empty | | rabbit |
| 217 | KIT_sdi | Strategic Diagnostic Inc. | rabbit |
| 218 | CD8A_sdi | Strategic Diagnostic Inc. | rabbit |
| 219 | CD3E_sdi | Strategic Diagnostic Inc. | rabbit |
| 220 | CD4_sdi | Strategic Diagnostic Inc. | rabbit |
| 221 | FGFR4_sdi | Strategic Diagnostic Inc. | rabbit |
| 222 | mmP10_sdi | Strategic Diagnostic Inc. | rabbit |
| 223 | ETV4_sdi | Strategic Diagnostic Inc. | rabbit |
| 224 | empty | | rabbit |
| 225 | GSDmL_sdi | Strategic Diagnostic Inc. | rabbit |
| 226 | RAB25_sdi | Strategic Diagnostic Inc. | rabbit |
| 227 | SCN9a_sdi | Strategic Diagnostic Inc. | rabbit |
| 228 | CCL2_sdi | Strategic Diagnostic Inc. | rabbit |
| 229 | XBP1_sdi | Strategic Diagnostic Inc. | rabbit |
| 230 | CCL14_sdi | Strategic Diagnostic Inc. | rabbit |
| 231 | empty | | rabbit |
| 232 | CD46_sdi | Strategic Diagnostic Inc. | rabbit |
| 233 | IL6ST_sdi | Strategic Diagnostic Inc. | rabbit |
| 234 | CDK6_sdi | Strategic Diagnostic Inc. | rabbit |
| 235 | VAPB_sdi | Strategic Diagnostic Inc. | rabbit |
| 236 | mLLT10_sdi | Strategic Diagnostic Inc. | rabbit |
| 237 | PTCH_sdi | Strategic Diagnostic Inc. | rabbit |
| 238 | empty | | rabbit |
| 239 | PmL_sdi | Strategic Diagnostic Inc. | rabbit |
| 240 | C1orf38_sdi | Strategic Diagnostic Inc. | rabbit |
| 241 | BAG4_sdi | Strategic Diagnostic Inc. | rabbit |
| 242 | SLD5_sdi | Strategic Diagnostic Inc. | rabbit |
| 243 | TBC1D3_sdi | Strategic Diagnostic Inc. | rabbit |
| 244 | OPN3_sdi | Strategic Diagnostic Inc. | rabbit |
| 245 | LOC441347_sdi | Strategic Diagnostic Inc. | rabbit |
| 1000 | Akt PKB biosource phospho | Invitrogen Biosource | rabbit |
| 1001 | Kit_pY823 | Invitrogen Biosource | rabbit |
| 1002 | Cortactin_pY421 | Invitrogen Biosource | rabbit |
| 1003 | EGFR_pY845 not much left | Invitrogen Biosource | rabbit |
| 1004 | Elk-1_pS383 | Invitrogen Biosource | rabbit |
| 1005 | FAK_pY397 | Invitrogen Biosource | rabbit |
| 1006 | ATF2_69/71 | Invitrogen Biosource | rabbit |
| 1007 | Kit_pY936 | Invitrogen Biosource | rabbit |
| 1008 | Cortactin_pY421 | Invitrogen Biosource | rabbit |
| 1009 | elF2alpha_pS52 | Invitrogen Biosource | rabbit |
| 1010 | Erb-2_pY1139 | Invitrogen Biosource | rabbit |
| 1011 | FAK_pY407 | Invitrogen Biosource | rabbit |
| 1012 | atf2_t71 | Invitrogen Biosource | rabbit |
| 1013 | Kit_pYpY568/570 | Invitrogen Biosource | rabbit |
| 1014 | Raf_pS43 | Invitrogen Biosource | rabbit |
| 1015 | elF4E_pS209 | Invitrogen Biosource | rabbit |
| 1016 | erk5_T218_Y220 | Invitrogen Biosource | rabbit |
| 1017 | FAk_pY576 | Invitrogen Biosource | rabbit |
| 1018 | Abl_pY245 | Invitrogen Biosource | rabbit |
| 1019 | met_pY1003 | Invitrogen Biosource | rabbit |
| 1020 | Raf_pYpY340/341 | Invitrogen Biosource | rabbit |
| 1021 | elF4G_pS1108 | Invitrogen Biosource | rabbit |
| 1022 | ETS1_pS282 | Invitrogen Biosource | rabbit |
| 1023 | FAK_pY577 | Invitrogen Biosource | rabbit |
| 1024 | Kit_pY703 | Invitrogen Biosource | rabbit |
| 1025 | met_pYpYpY1230/1234/1235 | Invitrogen Biosource | rabbit |
| 1026 | empty | | rabbit |
| 1027 | elf2AS52 | Invitrogen Biosource | rabbit |
| 1028 | ETS1_pSpS282/285 | Invitrogen Biosource | rabbit |
| 1029 | FAK_pY861 | Invitrogen Biosource | rabbit |
| 1030 | fak_y397 | Invitrogen Biosource | rabbit |
| 1031 | IKKa_s176s180 | Invitrogen Biosource | rabbit |
| 1032 | IRS-1_pY1229 | Invitrogen Biosource | rabbit |
| 1033 | JNK1&2 SAPK_T183Y185 | Invitrogen Biosource | rabbit |
| 1034 | mEK1_T292 | Invitrogen Biosource | rabbit |
| 1035 | parp_214/215 | Invitrogen Biosource | rabbit |
| 1036 | FAK_Y576 | Invitrogen Biosource | rabbit |
| 1037 | Integrinbeta3_py773 | Invitrogen Biosource | rabbit |
| 1038 | IRS-1_pY612 | Invitrogen Biosource | rabbit |
| 1039 | vinculin_y1065 | Invitrogen Biosource | rabbit |
| 1040 | mEK2_s394 | Invitrogen Biosource | rabbit |
| 1041 | Paxillin_pS126 | Invitrogen Biosource | rabbit |
| 1042 | gsk3b_s9 | Invitrogen Biosource | rabbit |
| 1043 | IRS-1_pS312 | Invitrogen Biosource | rabbit |
| 1044 | JAk1_pYpY1022/1023 | Invitrogen Biosource | rabbit |
| 1045 | vinvulin_y100 | Invitrogen Biosource | rabbit |
| 1046 | mTOR/FRAP_pS2448 | Invitrogen Biosource | rabbit |
| 1047 | Paxillin_pY118 | Invitrogen Biosource | rabbit |
| 1048 | GSK-3beta_/_GSK-3alpha | Invitrogen Biosource | rabbit |
| 1049 | IRS-1_pS616 | Invitrogen Biosource | rabbit |
| 1050 | jnk1/2_T183/y185 | Invitrogen Biosource | rabbit |
| 1051 | LAT_pY191 | Invitrogen Biosource | rabbit |
| 1052 | p70S6K_pT229 | Invitrogen Biosource | rabbit |
| 1053 | Paxillin_pY31 | Invitrogen Biosource | rabbit |
| 1054 | Hck_Y209/pS211 | Invitrogen Biosource | rabbit |
| 1055 | IRS-1_pY1179 | Invitrogen Biosource | rabbit |
| 1056 | jnk1&2 SAPK_T183Y185 | Invitrogen Biosource | rabbit |
| 1057 | Lck_pY192 | Invitrogen Biosource | rabbit |
| 1058 | PAK1/2/3_pT423 | Invitrogen Biosource | rabbit |
| 1059 | PDGFRalpha_pY742 | Invitrogen Biosource | rabbit |
| 1060 | Ubiquitin SPA-202 AD | Assay designs | mouse IgG1 |
| 1061 | membrin PT046 | Assay designs | mouse IgG1 |
| 1062 | SAP97 | Assay designs | mouse IgG1 |
| 1063 | CD40L | Assay designs | mouse IgG1 |
| 1064 | SNAP-25 | Assay designs | mouse IgG1 |
| 1065 | OPN | Assay designs | mouse IgG2a |
| 1066 | Ubiquitin SPA-201 | Assay designs | mouse IgG1 |
| 1067 | HIF-1beta OSA-250 | Assay designs | mouse IgG1 |
| 1068 | mytag | Assay designs | mouse IgG1 |
| 1069 | CD45 | Assay designs | mouse IgG1 |
| 1070 | skap1 mem | Assay designs | mouse IgG1 |
| 1071 | ARF1 | Assay designs | mouse IgG2a |
| 1072 | multi-Ubiquitin SPA-205 | Assay designs | mouse IgG1 |
| 1073 | HO-1 OSA-110 | Assay designs | mouse IgG1 |
| 1074 | Neurofilament NF-L | Assay designs | mouse IgG1 |
| 1075 | CD74 | Assay designs | mouse IgG1 |
| 1076 | lime09 mem | Horejsi | mouse IgG1 |
| 1077 | HIF-1alpha | Assay designs | mouse IgG2a |
| 1078 | Calreticulin SPA-601 | Assay designs | mouse IgG1 |
| 1079 | KDEL receptor PT048 | Assay designs | mouse IgG1 |
| 1080 | Agrin | Assay designs | mouse IgG1 |
| 1081 | GAD65/67 | Assay designs | mouse IgG1 |
| 1082 | lime11 mem | Assay designs | mouse IgG1 |
| 1083 | PKCalpha | Assay designs | mouse IgG2a |
| 1084 | Cyclooxygenase1 COX-010 | Assay designs | mouse IgG1 |
| 1085 | ER ad | Assay designs | mouse IgG1 |
| 1086 | ERp57 | Assay designs | mouse IgG1 |
| 1087 | VEGF | Assay designs | mouse IgG1 |
| 1088 | JNK1/2 R&D | R&D | mouse IgG2a |
| 1089 | beta-actin | Sigma | mouse IgG2a |
| 1090 | lkBe BD g2a | Bdbiosciences | mouse IgG2a |
| 1091 | mEK2 BD g2a | Bdbiosciences | mouse IgG2a |
| 1092 | B2m-01 g2a | Horejsi | mouse IgG2a |
| 1093 | stat5 BD g2b | Bdbiosciences | mouse IgG2b |
| 1094 | bcr sc20707 rbt poly | Santa Cruz | rabbit |
| 1095 | erk sc7976 | Santa Cruz | goat |
| 1096 | stat3 BD g2a | Bdbiosciences | mouse IgG2a |
| 1097 | p90 rsk BD g2a | Bdbiosciences | mouse IgG2a |
| 1098 | empty | | |
| 1099 | Fyn BD g2b | Bdbiosciences | mouse IgG2b |
| 1100 | bcr sc885 | Santa Cruz | rabbit |
| 1101 | Calcineurin A AD rbt poly | Assay designs | rabbit |
| 1102 | pi3k BD g2a | Bdbiosciences | mouse igg2a |
| 1103 | trim 4 g2a | Horejsi | mouse IgG2a |
| 1104 | JAK1 BD | Bdbiosciences | mouse IgG2b |
| 1105 | Bad BD g2b | Bdbiosciences | mouse IgG2b |
| 1106 | bcr sc886 | Santa Cruz | rabbit |
| 1107 | nNOS AD | Assay designs | rabbit |
| 1108 | erk pan BD g2a | Bdbiosciences | mouse IgG2a |
| 1109 | mHCII m266 | Horejsi | mouse IgG2a |
| 1110 | empty | | |
| 1111 | erk2 BD g2b | Bdbiosciences | mouse IgG2b |
| 1112 | abl sc131x | Santa Cruz | rabbit |
| 1113 | Erythrocyte Catalase AD | Assay designs | rabbit |
| 1114 | mEK1 BD g2a | Bdbiosciences | mouse IgG2a |
| 1115 | sit 4 g2a | Horejsi | mouse IgG2a |
| 1116 | stat1 BD g2b | Bdbiosciences | mouse IgG2b |
| 1117 | empty | | |
| 1118 | abl sc887 | Santa Cruz | rabbit |
| 1119 | Ras AD | Assay designs | rabbit |
| 1120 | CD14 m15 | Horejsi | mouse IgG1 |
| 1121 | CD45 m151 | Horejsi | mouse IgG1 |
| 1122 | ptyr01 | Horejsi | mouse IgG1 |
| 1123 | CD18 m48 | Horejsi | mouse IgG1 |
| 1124 | ERK1 BD | Bdbiosciences | mouse IgG1 |
| 1125 | stat2 BD | Bdbiosciences | mouse IgG1 |
| 1126 | mHCII m36 | Horejsi | mouse IgG1 |
| 1127 | CD97 m180 | Horejsi | mouse IgG1 |
| 1128 | CD7 m186 | Horejsi | mouse IgG1 |
| 1129 | LAT02 | Horejsi | mouse IgG1 |
| 1130 | mEK5 BD | Bdbiosciences | mouse IgG1 |
| 1131 | Lck BD | Bdbiosciences | mouse IgG1 |
| 1132 | CD71 m75 | Horejsi | mouse IgG1 |
| 1133 | CD48 m201 | Horejsi | mouse IgG1 |
| 1134 | CD6 m98 | Horejsi | mouse IgG1 |
| 1135 | CD117 SCFRalpha | Immunex | mouse IgG1 |
| 1136 | mKP2 BD | Bdbiosciences | mouse IgG1 |
| 1137 | tyk2 BD | Bdbiosciences | mouse IgG1 |
| 1138 | Cd10 mEm78 | Horejsi | mouse IgG1 |
| 1139 | CD80 m234 | Horejsi | mouse IgG1 |
| 1140 | CD300 m260 | Horejsi | mouse IgG1 |
| 1141 | CD2 m65 | Horejsi | mouse IgG1 |
| 1142 | p70s6k BD | Bdbiosciences | mouse IgG1 |
| 1143 | tyk2 BD | Bdbiosciences | mouse IgG1 |
| 1144 | CD18 m148 | Horejsi | mouse IgG1 |
| 1145 | CD147 m6/6 | Horejsi | mouse IgG1 |
| 1146 | m03 b integrin like | Horejsi | mouse IgG1 |
| 1147 | TNFR m50 | Immunex | mouse IgG1 |
| 1148 | Tpl2 BD | Bdbiosciences | mouse IgG1 |
| 1149 | ZAP70 BD | Bdbiosciences | mouse IgG1 |
| 1150 | h2ax s139 | Assay designs | mouse IgG1 |
| 1151 | neurofilament nf-h | Assay designs | mouse IgG1 |
| 1152 | cdk1 (cdc2) | Assay designs | mouse IgG1 |
| 1153 | cyclin B1 | Assay designs | mouse IgG1 |
| 1154 | cdk4 BD | Bdbiosciences | mouse IgG1 |
| 1155 | pcna kam-cc240 | Assay designs | mouse IgG1 |
| 1156 | ubiquitin spa203 | Assay designs | mouse IgG1 |
| 1157 | hsp27 spa800 | Assay designs | mouse IgG1 |
| 1158 | cdk2 | Assay designs | mouse IgG1 |
| 1159 | cyclin D3 | Assay designs | mouse IgG1 |
| 1160 | p19 skp1 BD | Bdbiosciences | mouse IgG1 |
| 1161 | bcl2 aam-072 | Assay designs | mouse IgG1 |
| 1162 | lkBa s32/s36 | Assay designs | mouse IgG1 |
| 1163 | hsp90 spa830 | Assay designs | mouse IgG1 |
| 1164 | p53 s392 | Assay designs | mouse IgG1 |
| 1165 | cdk1/cdc2 BD | Bdbiosciences | mouse IgG1 |
| 1166 | rbbp BD | Bdbiosciences | mouse IgG1 |
| 1167 | rb prot ab kam-cp121 | Assay designs | mouse IgG1 |
| 1168 | vimentin s33 | Assay designs | mouse IgG1 |
| 1169 | hsp70 spa810 | Assay designs | mouse IgG1 |
| 1170 | p53 s 315 | Assay designs | mouse IgG1 |
| 1171 | pcna BD | Bdbiosciences | mouse IgG1 |
| 1172 | cyclin b BD | Bdbiosciences | mouse IgG1 |
| 1173 | dna-topoisomerase 2a/b | Assay designs | mouse IgG1 |
| 1174 | vimentin s6 | Assay designs | mouse IgG1 |
| 1175 | orc2 kam-cc235 | Assay designs | mouse IgG1 |
| 1176 | cenp-a kam-cc006 | Assay designs | mouse IgG1 |
| 1177 | p36/mat1BD | Bdbiosciences | mouse IgG1 |
| 1178 | atm kam-pk010 | Assay designs | mouse IgG1 |
| 1179 | dna-topoisomerase 2a p | Assay designs | mouse IgG1 |
| 1180 | erk sc7383 | Santa Cruz | mouse IgG2a |
| 1181 | empty | | |
| 1182 | 14-3-3 beta/e/l AD | Assay designs | mouse IgG2b |
| 1183 | p53 AD | Assay designs | mouse IgG2b |
| 1184 | empty | | |
| 1185 | stat5a R&D | R&D | mouse IgG3 |
| 1186 | bcr sc103 | Santa Cruz | mouse IgG2a |
| 1187 | empty | | |
| 1188 | erk2 sc1647 | Santa Cruz | mouse IgG2b |
| 1189 | 14-3-3 beta/l AD | Assay designs | mouse IgG2b |
| 1190 | empty | | |
| 1191 | chk1 AD | Assay designs | mouse IgG2b |
| 1192 | ptyr02 mem | Horejsi | mouse IgG2a |
| 1193 | empty | | |
| 1194 | stat3 R&D | R&D | mouse IgG2b |
| 1195 | PKCalpha BD | Bdbiosciences | mouse IgG2b |
| 1196 | empty | | |
| 1197 | trim2 mem | Horejsi | mouse IgG2a |
| 1198 | empty | | |
| 1199 | empty | | |
| 1200 | slp3 mem | Horejsi | mouse IgG2b |
| 1201 | PKARI BD | Bdbiosciences | mouse IgG2b |
| 1202 | empty | | |
| 1203 | empty | | |
| 1204 | empty | | |
| 1205 | empty | | |
| 1206 | Cyclin D3 BD | Bdbiosciences | mouse IgG2b |
| 1207 | PKCbeta BD | Bdbiosciences | mouse IgG2b |
| 1208 | empty | | |
| 1209 | empty | | |
| 1210 | PDGFRalpha y754 | Invitrogen Biosource | rabbit |
| 1211 | pkca t638 | Invitrogen Biosource | rabbit |
| 1212 | pkcg t655 | Invitrogen Biosource | rabbit |
| 1213 | pten s380/382/385 | Invitrogen Biosource | rabbit |
| 1214 | Rb s249/t252 | Invitrogen Biosource | rabbit |
| 1215 | stat1 s727 | Invitrogen Biosource | rabbit |
| 1216 | PDGFRalpha y762 | Invitrogen Biosource | rabbit |
| 1217 | pkcg t674 | Invitrogen Biosource | rabbit |
| 1218 | pkcg t674 | Invitrogen Biosource | rabbit |
| 1219 | pyk2 y402 | Invitrogen Biosource | rabbit |
| 1220 | p90 rsk1 s221/s227 | Invitrogen Biosource | rabbit |
| 1221 | vav1 y160 | Invitrogen Biosource | rabbit |
| 1222 | PKA RegIIbeta s114 | Invitrogen Biosource | rabbit |
| 1223 | pkcd s664 | Invitrogen Biosource | rabbit |
| 1224 | pkct s676 | Invitrogen Biosource | rabbit |
| 1225 | pyk2 y881 | Invitrogen Biosource | rabbit |
| 1226 | RP S6 s236 | Invitrogen Biosource | rabbit |
| 1227 | VEGFR2 y1214 | Invitrogen Biosource | rabbit |
| 1228 | empty | | rabbit |
| 1229 | pkcd y311 | Invitrogen Biosource | rabbit |
| 1230 | pkcn t655 | Invitrogen Biosource | rabbit |
| 1231 | pyk2 y881 | Invitrogen Biosource | rabbit |
| 1232 | SHP2 s576 | Invitrogen Biosource | rabbit |
| 1233 | VEGFR2 y951 | Invitrogen Biosource | rabbit |
| 1234 | PKA catalytic s338 | Invitrogen Biosource | rabbit |
| 1235 | pkcg t514 | Invitrogen Biosource | rabbit |
| 1236 | pten s380/382/383/385 | Invitrogen Biosource | rabbit |
| 1237 | Rac1 s71 | Invitrogen Biosource | rabbit |
| 1238 | src fam neg y site | Invitrogen Biosource | rabbit |
| 1239 | VEGFR2 y1054/1059 | Invitrogen Biosource | rabbit |
| 1240 | ISGF3g BD | Bdbiosciences | mouse IgG1 |
| 1241 | stat3 BD phospho | Bdbiosciences | mouse IgG1 |
| 1242 | FAK BD | Bdbiosciences | mouse IgG1 |
| 1243 | Hck BD | Bdbiosciences | mouse IgG1 |
| 1244 | Lyn BD | Bdbiosciences | mouse IgG1 |
| 1245 | Ctk/Ntk BD | Bdbiosciences | mouse IgG1 |
| 1246 | PYK2/CAKbeta BD | Bdbiosciences | mouse IgG1 |
| 1247 | Yes BD | Bdbiosciences | mouse IgG1 |
| 1248 | IKKbeta BD | Bdbiosciences | mouse IgG1 |
| 1249 | IKKg/NEmO BD | Bdbiosciences | mouse IgG1 |
| 1250 | IRAK BD | Bdbiosciences | mouse IgG1 |
| 1251 | NF-kbeta p65 BD | Bdbiosciences | mouse IgG1 |
| 1252 | stat1 phospho BD | Bdbiosciences | mouse IgG1 |
| 1253 | stat5 BD phospho | Bdbiosciences | mouse IgG1 |
| 1254 | stat5 BD phospho | Bdbiosciences | mouse IgG1 |
| 1255 | GSK-3beta BD | Bdbiosciences | mouse IgG1 |
| 1256 | InsulinR beta BD | Bdbiosciences | mouse IgG1 |
| 1257 | IRS-1 BD | Bdbiosciences | mouse IgG1 |
| 1258 | p70s6k BD | Bdbiosciences | mouse IgG1 |
| 1259 | Akt PKBa/ | Bdbiosciences | mouse IgG1 |
| 1260 | PKR/p68 BD | Bdbiosciences | mouse IgG1 |
| 1261 | Ref-1 BD | Bdbiosciences | mouse IgG1 |
| 1262 | TRADD | Bdbiosciences | mouse IgG1 |
| 1263 | PKBkinase/PDK1 | Bdbiosciences | mouse IgG1 |
| 1264 | PP2A catalytic alpha BD | Bdbiosciences | mouse IgG1 |
| 1265 | erk1/2 T202/Y204 | Bdbiosciences | mouse IgG1 |
| 1266 | JNK/SAPK1 BD | Bdbiosciences | mouse IgG1 |
| 1267 | p38alpha/SAPK2a BD | Bdbiosciences | mouse IgG1 |
| 1268 | p38mAPK BD | Bdbiosciences | mouse IgG1 |
| 1269 | erk1 BD | Bdbiosciences | mouse IgG1 |
| 1270 | bcl10 aam073 | Assay designs | mouse IgG1 |
| 1271 | cdk2 BD | Bdbiosciences | mouse IgG2a |
| 1272 | cyclin d1 kam-cc200 | Assay designs | mouse IgG2a |
| 1273 | rb prot kam-cp124 | Assay designs | mouse IgG2a |
| 1274 | hsp90b spa843 | Assay designs | mouse IgG2a |
| 1275 | hsp40 spa450 | Assay designs | mouse IgG2a |
| 1276 | nucleolin kam-cp100 | Assay designs | mouse IgG2a |
| 1277 | cdc25a kam-cc087 | Assay designs | mouse IgG2a |
| 1278 | cyclin E kam-cc205 | Assay designs | mouse IgG2a |
| 1279 | rb BD | Bdbiosciences | mouse IgG2a |
| 1280 | hsp90b spa842 | Assay designs | mouse IgG2a |
| 1281 | mcm3 kam-cc025 | Assay designs | mouse IgG2a |
| 1282 | P21/waf1 kam-cc003 | Assay designs | mouse IgG21 |
| 1283 | cdc25a kam-cc085 | Assay designs | mouse IgG2a |
| 1284 | cyclin A kam-cc190 | Assay designs | mouse IgG2a |
| 1285 | rbl2 BD | Bdbiosciences | mouse IgG2a |
| 1286 | hsp47 spa470 | Assay designs | mouse IgG2a |
| 1287 | mcm7 kam-cc230 | Assay designs | mouse IgG2a |
| 1288 | rangef (rcc1) | Assay designs | mouse IgG1 |
| 1289 | cdc25a kam-cc086 | Assay designs | mouse IgG2a |
| 1290 | cyclin D2 kam-cc202 | Assay designs | mouse IgG2a |
| 1291 | chk2 kam-cc112 | Assay designs | mouse IgG2a |
| 1292 | hsp70/hsc70 spa822 | Assay designs | mouse IgG2a |
| 1293 | tradd aam410 | Assay designs | mouse IgG2a |
| 1294 | p63 kam-cc241 | Assay designs | mouse IgG1 |
| 1295 | empty | | |
| 1296 | DNA-topoisomerase 2a kam-cc210 | Assay designs | mouse IgG1 |
| 1297 | chk2 kam-cc113 | Assay designs | mouse IgG2a |
| 1298 | hsp60 spa829 | Assay designs | mouse IgG2a |
| 1299 | empty | | |
| 1300 | jnk1 sc1648 | Santa Cruz | mouse IgG1 |
| 1301 | bcr sc20707 rbt poly | Santa Cruz | rabbit |
| 1302 | abl sc131x rbt poly | Santa Cruz | rabbit |
| 1303 | erk y204 rbt poly | Santa Cruz | rabbit |
| 1304 | pi3k p85 upstate | upstate | mouse IgG1 |
| 1305 | FAK 4.47 | upstate | mouse IgG1 |
| 1306 | jnk2 sc7345 | Santa Cruz | mouse IgG1 |
| 1307 | bcr sc885 rbt poly | Santa Cruz | rabbit |
| 1308 | abl sc887 rbt poly | Santa Cruz | rabbit |
| 1309 | CD115 c-fms | r&d | mouse IgG1 |
| 1310 | Akt/PKB upstate | upstate | mouse IgG1 |
| 1311 | GRB2 upstate | upstate | mouse IgG1 |
| 1312 | PLCg-1 IgGs | upstate | mouse IgG1 |
| 1313 | bcr sc886 rbt poly | Santa Cruz | rabbit |
| 1314 | PICg-1 D-7-3 upstate | upstate | mouse IgG1 |
| 1315 | Paxillin upstate | upstate | mouse IgG2a |
| 1316 | CD98 m108 | Horejsi | mouse IgG2a |
| 1317 | lime05 | Horejsi | mouse IgG2a |
| 1318 | CD3e m57 | Horejsi | mouse IgG2a |
| 1319 | CD8 m31 | Horejsi | mouse IgG2a |
| 1320 | Syk upstate | upstate | mouse IgG2a |
| 1321 | CRKL upstate | upstate | mouse IgG2a |
| 1322 | CD46 m258 | Horejsi | mouse IgG2a |
| 1323 | mHC II m138 | Horejsi | mouse IgG2a |
| 1324 | CD71 m105 | Horejsi | mouse IgG2a |
| 1325 | m262 TCRbv5 | Horejsi | mouse IgG2a |
| 1326 | CD45 m71 | Horejsi | mouse IgG2a |
| 1327 | SKAP-03 | Horejsi | mouse IgG2b |
| 1328 | lime01 | Horejsi | mouse IgG2a |
| 1329 | lime02 | Horejsi | mouse IgG2a |
| 1330 | Akt1/2/3 PT308 | Santa Cruz | rabbit |
| 1331 | Akt1/2/3 Ps473 | Santa Cruz | rabbit |
| 1332 | caml Y99 | Santa Cruz | rabbit |
| 1333 | Caml Y138 | Santa Cruz | rabbit |
| 1334 | Caml s81 | Santa Cruz | rabbit |
| 1335 | CDK1/CDC2 p34 Y15 | Santa Cruz | rabbit |
| 1336 | CDK1/CDC2 p34 T14/Y15 | Santa Cruz | rabbit |
| 1337 | kit Y568/570 | Santa Cruz | rabbit |
| 1338 | kit Y721 | Santa Cruz | rabbit |
| 1339 | jun s73 | Santa Cruz | rabbit |
| 1340 | Cbl Y700 | Santa Cruz | rabbit |
| 1341 | Cofilin1 S3 | Santa Cruz | rabbit |
| 1342 | CREB1 S133 | Santa Cruz | rabbit |
| 1343 | connexin43 mS262 | Santa Cruz | rabbit |
| 1344 | Src Y216 | Santa Cruz | rabbit |
| 1345 | Ezrin Y146 | Santa Cruz | rabbit |
| 1346 | Ezrin Y354 | Santa Cruz | rabbit |
| 1347 | EGFR Y1173 | Santa Cruz | rabbit |
| 1348 | EGFR Y1110 | Santa Cruz | rabbit |
| 1349 | EpoR 479 | Santa Cruz | rabbit |
| 1350 | Flk-1 Y996 | Santa Cruz | rabbit |
| 1351 | FKHR s256 | Santa Cruz | rabbit |
| 1352 | JAK1 Y1022/1023 | Santa Cruz | rabbit |
| 1353 | JIP-3 E-18 | Santa Cruz | rabbit |
| 1354 | IRS1/2 s270 | Santa Cruz | rabbit |
| 1355 | IRS1/2 Y612 | Santa Cruz | rabbit |
| 1356 | IRS1 Y465 | Santa Cruz | rabbit |
| 1357 | IRS1 s641 | Santa Cruz | rabbit |
| 1358 | IRS1 Y632 | Santa Cruz | rabbit |
| 1359 | IRS1Y1229 | Santa Cruz | rabbit |
| 1360 | erk1 s94 | Santa Cruz | rabbit |
| 1361 | jnk1 17 | Santa Cruz | rabbit |
| 1362 | CDK1 cdc2 kap-cc001c | Assay designs | rabbit |
| 1363 | caspase3 aap-113 | Assay designs | rabbit |
| 1364 | caspase7 aap-107 | Assay designs | rabbit |
| 1365 | ikka kap-tf116 | Assay designs | rabbit |
| 1366 | erk2 k-23 153 | Santa Cruz | rabbit |
| 1367 | jnk1 fl | Santa Cruz | rabbit |
| 1368 | cdk6 kap-cc006 | Assay designs | rabbit |
| 1369 | caspase3 aas-103 | Assay designs | rabbit |
| 1370 | caspase7 aap-137 | Assay designs | rabbit |
| 1371 | ikka kap-tf115 | Assay designs | rabbit |
| 1372 | erk2 14 154 | Santa Cruz | rabbit |
| 1373 | jnk2 n-18 | Santa Cruz | rabbit |
| 1374 | cdk7/m015-ct | Assay designs | rabbit |
| 1375 | caspase4 aap-104 | Assay designs | rabbit |
| 1376 | caspase9 aap-109 | Assay designs | rabbit |
| 1377 | ikkb kap-tf118 | Assay designs | rabbit |
| 1378 | erk1/2 ad | Assay designs | rabbit |
| 1379 | sgk1 nt | Assay designs | rabbit |
| 1380 | cdk2 kap-cc007c | Assay designs | rabbit |
| 1381 | caspase5 aap-105 | Assay designs | rabbit |
| 1382 | caspase12 aap-122 | Assay designs | rabbit |
| 1383 | ikke kap-tf131 | Assay designs | rabbit |
| 1384 | mapkapk-2 ad | Assay designs | rabbit |
| 1385 | sgk1 ct | Assay designs | rabbit |
| 1386 | sarm csa509 | Assay designs | rabbit |
| 1387 | caspase6 aap-106 | Assay designs | rabbit |
| 1388 | apaf1 aap-300 | Assay designs | rabbit |
| 1389 | ikkg (nemo) kap-tf132 | Assay designs | rabbit |
| 1390 | crystallin s45 | Assay designs | rabbit |
| 1391 | caveolin2 s36 | Assay designs | rabbit |
| 1392 | gsk3a/b | Assay designs | rabbit |
| 1393 | hsp27 spa525 | Assay designs | rabbit |
| 1394 | jak2 y1007/y1008 | Assay designs | rabbit |
| 1395 | mek1/2 s218/222 | Assay designs | rabbit |
| 1396 | crystallin s19 | Assay designs | rabbit |
| 1397 | bad s112 | Assay designs | rabbit |
| 1398 | gsk3b s9 | Assay designs | rabbit |
| 1399 | histone h3 s28 | Assay designs | rabbit |
| 1400 | jak1 y1022/y1023 | Assay designs | rabbit |
| 1401 | marcks s152/156 | Assay designs | rabbit |
| 1402 | kit y823 | Assay designs | rabbit |
| 1403 | elf2a s52 | Assay designs | rabbit |
| 1404 | p-tyrosine hydroxylase s40 | Assay designs | rabbit |
| 1405 | insulin r csa720 | Assay designs | rabbit |
| 1406 | mek1 s298 | Assay designs | rabbit |
| 1407 | p38 mapk dual phospho AD | Assay designs | rabbit |
| 1408 | CDK1/CDC2 y15 | Assay designs | rabbit |
| 1409 | erk 1/2 phospho AD | Assay designs | rabbit |
| 1410 | hsp27 s82 not enough left | Assay designs | rabbit |
| 1411 | irs1 y612 | Assay designs | rabbit |
| 1412 | mek1 t292 | Assay designs | rabbit |
| 1413 | paxillin y118 | Assay designs | rabbit |
| 1414 | camkii t286 | Assay designs | rabbit |
| 1415 | elk1 s383 | Assay designs | rabbit |
| 1416 | hsp27 s78 | Assay designs | rabbit |
| 1417 | jnk1/2 t183/y185 | Assay designs | rabbit |
| 1418 | mek1 t386 | Assay designs | rabbit |
| 1419 | pkcg t514 | Assay designs | rabbit |
| 1420 | Histone H3 s10 | Santa Cruz | rabbit |
| 1421 | lkBa s32 | Santa Cruz | rabbit |
| 1422 | Rac1 s71 | Santa Cruz | rabbit |
| 1423 | nPKCd Y187 | Santa Cruz | rabbit |
| 1424 | PKAa s96 | Santa Cruz | rabbit |
| 1425 | paxillin Y31 | Santa Cruz | rabbit |
| 1426 | HSP27 s82 | Santa Cruz | rabbit |
| 1427 | IKKa/b T23 | Santa Cruz | rabbit |
| 1428 | p90 Rsk1/2/4 S363 | Santa Cruz | rabbit |
| 1429 | nPKCd Y52 | Santa Cruz | rabbit |
| 1430 | PYK2 Y579 | Santa Cruz | rabbit |
| 1431 | paxillin Y118 | Santa Cruz | rabbit |
| 1432 | Hck Y411 | Santa Cruz | rabbit |
| 1433 | JAK2 Y1007/1008 | Santa Cruz | rabbit |
| 1434 | Raf1 s259 | Santa Cruz | rabbit |
| 1435 | nPKCd T507 | Santa Cruz | rabbit |
| 1436 | PYK2 Y579/580 | Santa Cruz | rabbit |
| 1437 | PKC T410 | Santa Cruz | rabbit |
| 1438 | mLCK Y464 | Santa Cruz | rabbit |
| 1439 | JNK T183/Y185 | Santa Cruz | rabbit |
| 1440 | Raf1 Y340/341 | Santa Cruz | rabbit |
| 1441 | nPKCd Y155 | Santa Cruz | rabbit |
| 1442 | PYK2 Y580 | Santa Cruz | rabbit |
| 1443 | PKCd Y311 | Santa Cruz | rabbit |
| 1444 | mLCK Y471 | Santa Cruz | rabbit |
| 1445 | IFN-aR1 Y466 | Santa Cruz | rabbit |
| 1446 | Ret Y1062 | Santa Cruz | rabbit |
| 1447 | nPKCd Y332 | Santa Cruz | rabbit |
| 1448 | p70S6k T421/s424 | Santa Cruz | rabbit |
| 1449 | PDGFRb Y857 | Santa Cruz | rabbit |
| 1450 | CD4 m241 | Horejsi | mouse IgG1 |
| 1451 | Cd4 m242 | Horejsi | mouse IgG1 |
| 1452 | CD8 m87 | Horejsi | mouse IgG1 |
| 1453 | CD8 m146 | Horejsi | mouse IgG1 |
| 1454 | CD11A m83 | Horejsi | mouse IgG1 |
| 1455 | CD222 m238 | Horejsi | mouse IgG1 |
| 1456 | CD11A m95 | Horejsi | mouse IgG1 |
| 1457 | lck-01 | Horejsi | mouse IgG1 |
| 1458 | CD11A m144 | Horejsi | mouse IgG1 |
| 1459 | CD43 m256 | Horejsi | mouse IgG1 |
| 1460 | mHCI m155 | Horejsi | mouse IgG1 |
| 1461 | mHCI m147 | Horejsi | mouse IgG1 |
| 1462 | CD43 m59 | Horejsi | mouse IgG1 |
| 1463 | CD5 m247 | Horejsi | mouse IgG1 |
| 1464 | CD11B m170 | Horejsi | mouse IgG1 |
| 1465 | CD43 m257 | Horejsi | mouse IgG1 |
| 1466 | Cd31 m05 | Horejsi | mouse IgG1 |
| 1467 | CD147 m6/7 | Horejsi | mouse IgG1 |
| 1468 | B2m02 | Horejsi | mouse IgG1 |
| 1469 | CD45 m28 | Horejsi | mouse IgG1 |
| 1470 | CD71 m189 | Horejsi | mouse IgG1 |
| 1471 | CD41 m06 | Horejsi | mouse IgG1 |
| 1472 | mHCii m136 | Horejsi | mouse IgG1 |
| 1473 | CD147 m6/1 | Horejsi | mouse IgG1 |
| 1474 | CD44 m263 | Horejsi | mouse IgG1 |
| 1475 | CD54 m112 | Horejsi | mouse IgG1 |
| 1476 | CD45ra m93 | Horejsi | mouse IgG1 |
| 1477 | CD29 m101a | Horejsi | mouse IgG1 |
| 1478 | csk04 | Horejsi | mouse IgG1 |
| 1479 | CD147 m6/8 | Horejsi | mouse IgG1 |
| 1480 | mek1-nt kap-mao010c | Assay designs | rabbit |
| 1481 | hsp20 spa796 | Assay designs | rabbit |
| 1482 | hsp90 spa846 | Assay designs | rabbit |
| 1483 | ec sod 105 | Assay designs | rabbit |
| 1484 | tnf-r1 csa-815 | Assay designs | rabbit |
| 1485 | irakm kap-st207 | Assay designs | rabbit |
| 1486 | mek2 kap-mao12 | Assay designs | rabbit |
| 1487 | hsp27 spa803 | Assay designs | rabbit |
| 1488 | hsp90a spa840 | Assay designs | rabbit |
| 1489 | cu/zn sod 101 | Assay designs | rabbit |
| 1490 | stat6 kap-tf007 | Assay designs | rabbit |
| 1491 | md2 csa506 | Assay designs | rabbit |
| 1492 | mek6 kap-mao14 | Assay designs | rabbit |
| 1493 | hsp40 spa400 | Assay designs | rabbit |
| 1494 | pkg kap-pk002 | Assay designs | rabbit |
| 1495 | mn sod 111 | Assay designs | rabbit |
| 1496 | survivin aap-275 | Assay designs | rabbit |
| 1497 | membrin vap.pt049 | Assay designs | rabbit |
| 1498 | mekk1 kap-sa001 | Assay designs | rabbit |
| 1499 | hsc70 spa816 | Assay designs | rabbit |
| 1500 | akt/pkb) kap-pk004 | Assay designs | rabbit |
| 1501 | mn sod 110 | Assay designs | rabbit |
| 1502 | hpk1 kap-sa008c | Assay designs | rabbit |
| 1503 | caveolin2 kap-st013 | Assay designs | rabbit |
| 1504 | pi3 kinase p85 | Assay designs | rabbit |
| 1505 | hsp70 spa811 | Assay designs | rabbit |
| 1506 | akt 2 pkbb kap-pk008 | Assay designs | rabbit |
| 1507 | cu/zn sod 100 | Assay designs | rabbit |
| 1508 | bim/bod aap330 | Assay designs | rabbit |
| 1509 | april csa836 | Assay designs | rabbit |
| 1510 | dna-pk kap-pi001 | Assay designs | rabbit |
| 1511 | p90 rsk1 kap-cc040 | Assay designs | rabbit |
| 1512 | bak aap030 | Assay designs | rabbit |
| 1513 | raidd aap270 | Assay designs | rabbit |
| 1514 | ciks act1 csa507 | Assay designs | rabbit |
| 1515 | hsf2 spa960 rat mono | Assay designs | rabbit |
| 1516 | kkialre kap-cc003 | Assay designs | rabbit |
| 1517 | sigirr csa-511 | Assay designs | rabbit |
| 1518 | mtor kap-st220 | Assay designs | rabbit |
| 1519 | traf2 aap422 | Assay designs | rabbit |
| 1520 | adam10 csa835 | Assay designs | rabbit |
| 1521 | dff45/icad aap451 | Assay designs | rabbit |
| 1522 | calreticulin spa600 | Assay designs | rabbit |
| 1523 | rap1 kap-gp125 | Assay designs | rabbit |
| 1524 | mcl1 aap-240 | Assay designs | rabbit |
| 1525 | inos kas.no001 | Assay designs | rabbit |
| 1526 | btk kap-tk101 | Assay designs | rabbit |
| 1527 | irak2 kap-st205 | Assay designs | rabbit |
| 1528 | p70 s6k kap-cc035 | Assay designs | rabbit |
| 1529 | bad aap-020 | Assay designs | rabbit |
| 1530 | a-raf kap-ma005 | Assay designs | rabbit |
| 1531 | nfkb rel kap-tf106 | Assay designs | rabbit |
| 1532 | elf2a kap-cp130 | Assay designs | rabbit |
| 1533 | phas1 kama110 | Assay designs | rabbit |
| 1534 | jkk1 kap-sa006c | Assay designs | rabbit |
| 1535 | syntaxin2 vap-sv065 | Assay designs | rabbit |
| 1536 | hsf1 spa901 | Assay designs | rabbit |
| 1537 | nik kap-st230 | Assay designs | rabbit |
| 1538 | ecsit csa508 | Assay designs | rabbit |
| 1539 | jun kap-tf104 | Assay designs | rabbit |
| 1540 | SLP-01 | Horejsi | mouse igg1 |
| 1541 | PAG02 | Horejsi | mouse igg1 |
| 1542 | vav ubi | upstate | mouse igg1 |
| 1543 | FAK AD | Assay designs | mouse igg1 |
| 1544 | NVL02 g2a | Horejsi | mouse IgG2a |
| 1545 | RAS01 | Horejsi | mouse IgG1 |
| 1546 | lat01 | Horejsi | mouse igg1 |
| 1547 | ZAP03 | Horejsi | mouse IgG1 |
| 1548 | src ubi | upstate | mouse igg1 |
| 1549 | HS-1 AD | Assay designs | mouse igg1 |
| 1550 | NVL07 g2a | Horejsi | mouse IgG2a |
| 1551 | NVL01 | Horejsi | mouse IgG1 |
| 1552 | nap06 | Horejsi | mouse IgG1 |
| 1553 | NAP02 | Horejsi | mouse IgG1 |
| 1554 | lat ubi | upstate | mouse igg1 |
| 1555 | pi3kalpha AD | Assay designs | mouse igg1 |
| 1556 | LST01 g2a | Horejsi | mouse IgG2a |
| 1557 | STAT1 phospho nano | nanotools | mouse igg1 |
| 1558 | slp02 | Horejsi | mouse IgG1 |
| 1559 | CD6_m100 | Horejsi | mouse IgG1 |
| 1560 | MEM-216 | Horejsi | mouse IgG1 |
| 1561 | beta-catenin AD | Assay designs | mouse igg1 |
| 1562 | AKT/PKBb nano g2a | nanotools | mouse IgG2a |
| 1563 | enos nano | nanotools | mouse igg1 |
| 1564 | sit01 | Horejsi | mouse IgG1 |
| 1565 | NAP08 | Horejsi | mouse IgG1 |
| 1566 | sos01 | Horejsi | mouse IgG1 |
| 1567 | LST02 | Horejsi | mouse IgG1 |
| 1568 | empty | | |
| 1569 | AKT/PKBa nano | nanotools | mouse igg1 |
| 1570 | Fyn_sc16 | Santa Cruz | rabbit |
| 1571 | zap_y292_sc12945 | Santa Cruz | rabbit |
| 1572 | empty | | |
| 1573 | EphrinA4_sc20719 | Santa Cruz | rabbit |
| 1574 | EphrinB1_sc1011 | Santa Cruz | rabbit |
| 1575 | jak3_sc513 | Santa Cruz | rabbit |
| 1576 | PI3K p110_sc8010 | Santa Cruz | mouse IgG2a |
| 1577 | lyn_sc7274 | Santa Cruz | mouse IgG2a |
| 1578 | PI3K p110g_sc1404 | Santa Cruz | goat |
| 1579 | RhoA_sc179 | Santa Cruz | rabbit |
| 1580 | syk4D10_sc1240 g2a | Santa Cruz | mouse IgG2a |
| 1581 | SHPTP1_sc287 | Santa Cruz | rabbit |
| 1582 | slp76_sc9062 | Santa Cruz | rabbit |
| 1583 | pyk2_sc1514 | Santa Cruz | goat |
| 1584 | SHPTP1_sc287 | Santa Cruz | rabbit |
| 1585 | EphrinB1_sc910 | Santa Cruz | rabbit |
| 1586 | empty | | |
| 1587 | empty | | |
| 1588 | syk_sc1077 | Santa Cruz | rabbit |
| 1589 | EphA1_sc925 | Santa Cruz | rabbit |
| 1590 | cortactin_sc11408 | Santa Cruz | rabbit |
| 1591 | empty | | |
| 1592 | PTPe_sc1117 | Santa Cruz | goat |
| 1593 | DOK1_sc6277 | Santa Cruz | goat |
| 1594 | lck_sc13 | Santa Cruz | rabbit |
| 1595 | Rap1_sc65 | Santa Cruz | rabbit |
| 1596 | empty | | |
| 1597 | grb2_sc255 | Santa Cruz | rabbit |
| 1598 | EphrinB2_sc1010 | Santa Cruz | rabbit |
| 1599 | CAS-L_sc6848 | Santa Cruz | goat |
| 1600 | jak2_sc278 | Santa Cruz | rabbit |
| 1601 | lck_sc13 | Santa Cruz | rabbit |
| 1602 | pI3K_y508_sc12929 | Santa Cruz | goat |
| 1603 | DOK1_sc6934 | Santa Cruz | rabbit |
| 1604 | EmT_sc23902_g1 | Santa Cruz | mouse IgG1 |
| 1605 | bcl-6_sc7388 | Santa Cruz | mouse IgG1 |
| 1606 | Akt1_sc1618 | Santa Cruz | goat |
| 1607 | Ezrin_sc6409 | Santa Cruz | goat |
| 1608 | empty | | |
| 1609 | Tm_sc18174 | Santa Cruz | goat |
| 1610 | empty | | |
| 1611 | vimentin_sc7557 | Santa Cruz | goat |
| 1612 | zap70_sc574 | Santa Cruz | rabbit |
| 1613 | cdc42_sc87 | Santa Cruz | rabbit |
| 1614 | empty | | |
| 1615 | nPKCe_sc726 | Santa Cruz | |
| 1616 | hsp70_sc1060 | Santa Cruz | goat |
| 1617 | EphB1_sc926 | Santa Cruz | rabbit |
| 1618 | CDC42 | Santa Cruz | |
| 1619 | Ephrin B1_sc1011 | Santa Cruz | rabbit |
| 1620 | ephrin a1 sc911? | Santa Cruz | rabbit |
| 1621 | EphAI_sc925? | Santa Cruz | rabbit |
| 1622 | stat5b_sc835 | Santa Cruz | rabbit |
| 1623 | EphA4_921 | Santa Cruz | rabbit |
| 1624 | empty | | |
| 1625 | bcl-6 sc858? | Santa Cruz | rabbit |
| 1626 | p130cas_sc860 | Santa Cruz | rabbit |
| 1627 | PU.1_sc352 | Santa Cruz | rabbit |
| 1628 | lyn_sc15 | Santa Cruz | rabbit |
| 1629 | Bcl-6 sc7388 | Santa Cruz | |
| 1630 | jnk3 SAPK1b | nanotools | mouse igg1 |
| 1631 | jnk SAPK1/2 | nanotools | mouse igg1 |
| 1632 | SAPK2delta | nanotools | mouse igg1 |
| 1633 | jnk2 SAPK1a | nanotools | mouse igg1 |
| 1634 | shc_y239/240 | nanotools | mouse igg1 |
| 1635 | shc | nanotools | mouse igg1 |
| 1636 | BAD Nanotools | nanotools | mouse igg1 |
| 1637 | hTFF3 | nanotools | mouse igg1 |
| 1638 | mKK7 n-terminus | nanotools | mouse igg1 |
| 1639 | mKK3 | nanotools | mouse igg1 |
| 1640 | shc_y317 | nanotools | mouse igg1 |
| 1641 | mAPK | nanotools | mouse igg1 |
| 1642 | Akt PKB_ps473 | nanotools | mouse igg1 |
| 1643 | AKT/PKB Nanotools | nanotools | mouse igg1 |
| 1644 | AKT/PKB_nonps473 | nanotools | mouse igg1 |
| 1645 | empty | | |
| 1646 | InsulinR_y1322 | nanotools | mouse igg1 |
| 1647 | InsulinR | nanotools | mouse igg1 |
| 1648 | IGFIR terminus | nanotools | mouse igg1 |
| 1649 | IGFIR_y1316 | nanotools | mouse igg1 |
| 1650 | p38 SAPK2a | nanotools | mouse igg1 |
| 1651 | CREB_s133 | nanotools | mouse igg1 |
| 1652 | STAT6 | nanotools | mouse igg1 |
| 1653 | mEK1/2 | nanotools | mouse igg1 |
| 1654 | fos n-terminus | nanotools | mouse igg1 |
| 1655 | fos_s374 | nanotools | mouse igg1 |
| 1656 | STAT3_s727 | nanotools | mouse igg1 |
| 1657 | STAT3_y705 | nanotools | mouse igg1 |
| 1658 | STAT5A/B_y694/699 | nanotools | mouse igg1 |
| 1659 | stat6_y641 | nanotools | mouse igg1 |

Labeling of proteins and incubation with antibody arrays: Cells were lysed on ice in a buffer containing 6 mM KCl 10 mM Hepes (pH8) and 10 mM MgCl2 (ref Mahony) and 0.1% Tween 20. The lysis buffer was supplemented with proteinase inhibitors (Sigma cat. No P8340), phosphatase inhibitors (Sigma Cat no P5726), 10 mM NaF and 0.1 mM TCEP. A freeze-thaw step was performed to enhance cell disruption, and the lysates centrifuged at 500 g for 10 min. The supernatant was collected as the water soluble fraction and contains cytoplasmic and nuclear proteins. The pellet containing non-solubilzed components and membranes was solubilized by the addition of 50 mM NaCl with 20 mM HEPES pH8 and 1% lauryl maltoside in HEPES buffered (20 mM pH8) saline. Proteins (1-10 mg/ml) were biotinylated with 500 ug/ml biotin-PEO-4-NHS for 20 min at 22° C. Free label was removed by passing the sample over a G50 sepharose spin column equilibrated with PBT.

Size exclusion chromatography: Biotinylated cellular proteins were loaded onto a Superdex 200 10/30 column (GE-biosciences) and separated on an Äkta FPLC system (GE-biosciences) at 4-8° C. using a flow rate of 0.2 ml/min and PBS with 0.05% Tween as running buffer. Fractions of 0.5 ml were collected. The column was calibrated with a high molecular weight standard kit from GE-biosciences.

Incubation of labeled proteins with arrays: Mixtures of particles were thawed, pelleted and resuspended in PBS casein block buffer (Pierce) with 40 ug/ml of mouse and goat gammaglobulins. Ten microliters of the suspension was added to wells of 96 well polypropylene PCR plates (Axygen). Proteins (100 ul) were added, the wells capped and plates rotated overnight at 4-8° C. Particles were then pelleted by centrifugation washed three times in PBT and labeled with 10 ul streptavidin-PE (2 ug/ml in PBS with 2% fetal bovine serum) Jackson Immunoresearch). Labeled particles were washed twice in PBT and analyzed by flow cytometry.

SDS-PAGE elution: Biotinylated proteins heated to 95° C. for 5 min in Laemnli sample buffer and separated on 4-16% gradient gels (www.Geba.org). Proteins with different molecular weight were eluted in separate fractions with a whole-gel eluter (www.biorad.com) according to the recommendations of the manufacturer. Eluates were run over G50 sepharose with PBT in filter-bottomed microwell plates (Millipore) prior to incubation with the arrays.

Immunoprecipitation: Antibodies were coupled to polymer particles with protein G and anti-Fc as described above. Ten microliters of a 1% particle suspension in casein blocking buffer was added to 100 ul PBT containing 50 ug of biotinylated. The particles were rotated at 4° C. overnight, and washed three times. Proteins were eluted by heating particles in PBS with 1% SDs to 95° C. for 5 min. The supernatant was diluted 1:10 in PBT before addition to arrays. Anti-phosphotyrosine immunoprecipitates were eluted by incubation in PBT with 50 mM phenylphosphate and biotinylated as described above.

Flow cytometry and data analysis: An LSRII flow cytometer was used to collect data. Pacific Blue and Pacific Orange were excited by a 405 laser using 450 and 530 band pass filters, respectively. Alexa 488, Phycoerythrin (PE) and PE-Cy7 were excited by a 488 nm laser and light collected through 530BP, 585BP and 780BP filters, respectively. Alexa 647 was excited by a 633 nm laser and light collected through a 655BP filter. Linearized values for median PE fluorescence for all particle populations were extracted by the FACSDiva software and exported to Excel spreadsheets. Since the FACSDiva software only accommodates 256 regions, each array was analyzed with four different analysis worksheets and all data exported to a single Excel spreadsheet. Data were formatted in Excel by matching the rows with a table for the antibodies and the file stored as tab-limited text for analysis with the publicly available programs “Cluster” and “Tree view” from Michael Eisen's laboratory (http://rana.lbl.gov/EisenSoftware.htm). Unless otherwise stated, values were log transformed, columns (samples) median centered and normalized using functions of the “Cluster” program.

### Example 1

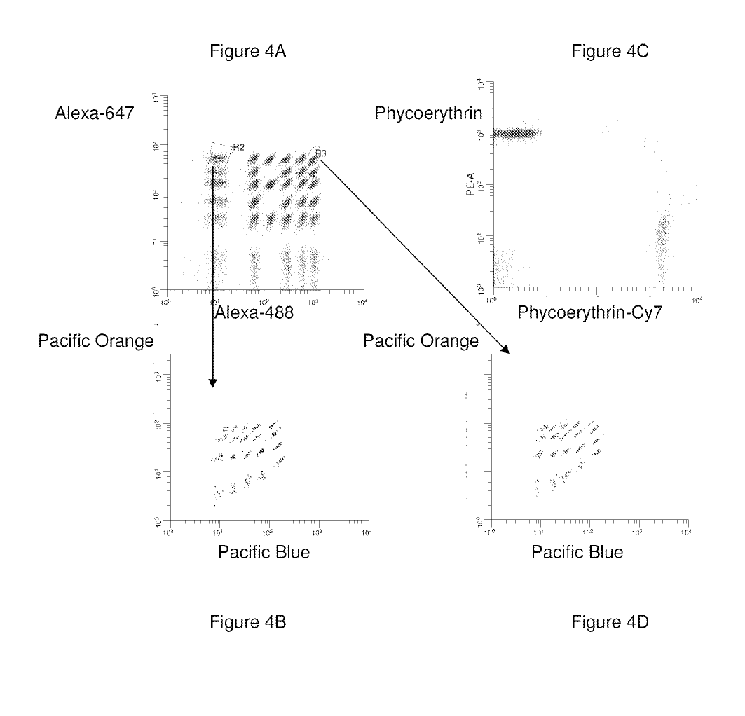

Polymer particles were coupled to protein G and labeled with maleimide derivatives of Alexa 488, Alexa 647, Pacific Blue and Pacific Orange as described in materials and methods. A mixture of 720 different particles was incubated with goat anti-mouse IgG1. Three equal aliquots were incubated with CD34 PE (IgG1), CD64 biotin (IgG1) streptavidin PECy7, and non-immune mouse IgG. The particles were then washed and mixed in the presence of 40 ug/ml non-immune mouse and goat gammaglobulins. The particles were analysed by flow cytometry and the results are shown in FIG. 4. FIG. 4A shows the correspondence between particles displaying Alexa 488 (FL1) and Alexa 647 (FL2) fluorescence. FIGS. 4B and 4D show the correspondence between particles displaying Pacific Blue (FL4) and Pacific Orange (FL3), the fluorescence of particles being gated on gates 1 and 2. FIG. 4C shows the correspondence between particles displaying PE (FL5) fluorescence from bound CD34 antibody and PE-Cy7 (FL6) fluorescence from CD64 biotin/Streptavidin PECy7.

### Example 2

This example relates to large-scale analysis of cell cycle machinery. A schematic diagram of the steps involved is shown in FIG. 3. Twenty fractions containing proteins and complexes of different size (range 670-10 kDa) were added to separate wells of a 96 well plate. A bead-suspension array consisting of 600 populations of fluorescently labelled particles, each with a different antibody bound, was added to each well. The particles were incubated overnight, washed to remove unbound proteins and labelled with fluorescent streptavidin (streptavidin Phycoerythrin, Jackson Immunoresearch). The particles were washed again and analyzed in an LSRII flow cytometer (BD biosciences). Values for streptavidin-PE fluorescence of each particle population were exported to a spreadsheet where each column represents a measured fraction and each row the streptavidin-PE signal measured from the 600 particle populations.

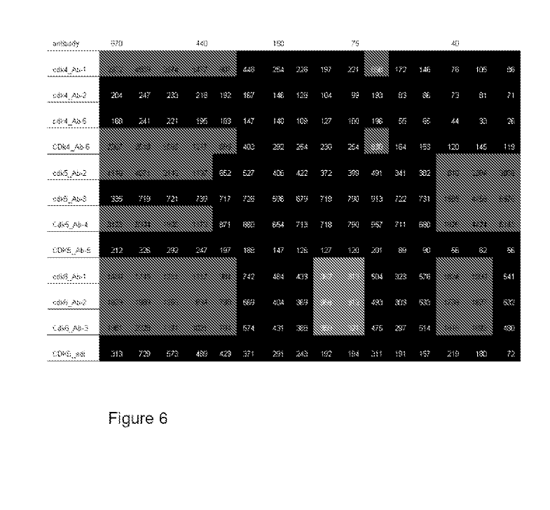

A schematic illustration of some of the results is shown in FIG. 5. Row A illustrates detection of overlapping specificity of two antibodies to the same target in fraction 4, whereas cross-reactivity is observed in fractions 1 and 7. Row B shows no overlap in specificity. Row C shows detection of monomeric protein in fraction 7 and complex in fraction 1. The two antibodies detect two different biopolymers, i.e the monomer and the complex. The overlaps in specificity are illustrated by the ellipses.

The spreadsheet data were formatted in a publicly available computer program designed for clustering DNA microarray data (Cluster, ref Eisen)) and visualized with a graphical program that presents the data in the form of a color-map (heat map) (TreeView) which is shown in FIG. 6. Each column corresponds to a fraction. Each row corresponds to the signal measured from a particle displaying antibodies with the indicated specificity. Dark grey, black and light grey pixels indicate values above, at and below the median, respectively. The data on FIG. 6 illustrate the relative signal in each fraction, thus effectively representing elution curves of the size exclusion chromatography separation for all the antibody targets.

### Example 3

Proteins in the cell cycle machinery interact as networks of multi-molecular complexes. To identify multiple components in their different forms a whole cell lysate (cell line Jurkat or ML2) was first labelled with an amino-reactive form of biotin (biotin-NHS) and then subjected to size exclusion chromatography on a Superdex 200 column (GE-biosciences). Fractions of 500 ul were collected, each containing proteins with different sizes. An equal volume of each fraction (30 ul) was added to separate wells of a 96 well plate. Aliquots of a mixture of colored particles with antibodies was then added to each well and the plate was rotated overnight at 4-8° C. The plate was then centrifuged at 600 g for 4 min, the supernatants discarded and the pellet resuspended in PBT. This step was repeated twice. The particles were then labelled with phycoerythrin-conjugated streptavidin on ice for 15 min, washed twice in PBT and finally resuspended in 250 ul PBT and analyzed by flow cytometry.

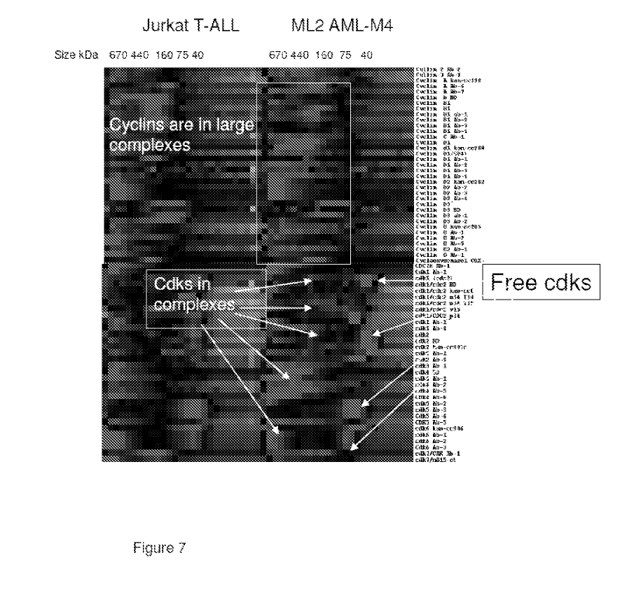

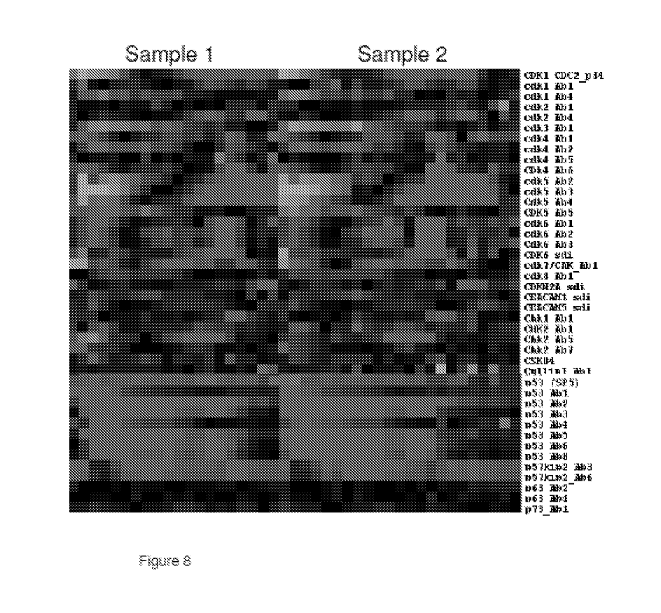

As shown by the results in FIG. 7, antibodies to different cyclins and cyclin-dependent kinases had distinct patterns of reactivity towards the fractions. The patterns were reproducible among different antibodies to the same target. The size distribution of cyclin/cdk complexes of two leukemic cell lines is shown. The data are obtained are well in line with previous reports. Cyclins occur only as large complexes because these proteins are unstable in free forms, whereas cdks occur both in free forms and multiple different large complexes. (20)

### Example 4

This example was carried out to show the reproducibility of complex antigen-specific patterns produced by fractionation of a cell lysate on a superdex size exclusion column. Two independent cultures of 3T3 cells (mouse embryonic fibroblasts) were treated in parallel in the same way as in Examples 2 and 3. The results were compiled and are shown in FIG. 8. The complex antigen-dependent patterns were reproducible among different antibodies to the same targets and between samples.

### Example 5

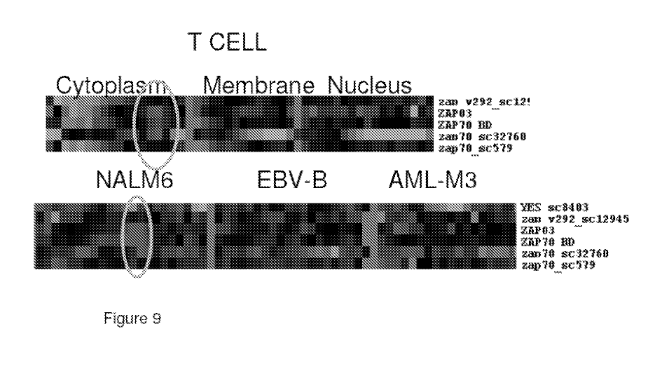

This example relates to detection of overlapping antibody specificity. Different cell lines expressing the protein tyrosine kinase ZAP-70 or not were lysed and proteins separated and analyzed as described in examples 2 and 3. The results were compiled and are shown in FIG. 9. The tyrosine kinase ZAP-70 is expressed in T cells and in the B cell line NALM6. Here three antibodies against ZAP-70 captured protein from the same cytoplasmic fractions of a T cell line, whereas one (sc579 did not). In non-T cells, reactivity was observed for all antibodies. Yet, a clear overlap in reactivity pattern was only observed for NALM-6. The antibody sc32760 had a major reactivity in a fraction containing large proteins from all cell types.

### Example 6

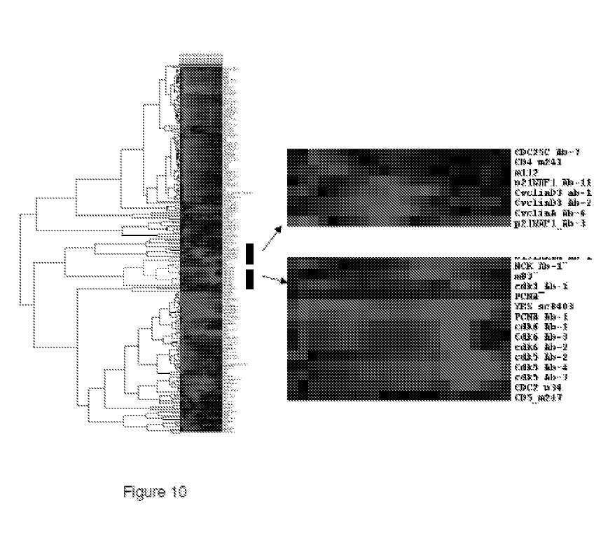

This example relates to the automated detection of overlapping antibody specificity by cluster analysis. Cluster analysis is widely used in analysis of DNA microarray data (24). The algorithms group values on the basis of their co-variability in a series of samples. In this example, antibodies in a 120-plex were clustered according to reactivity with fractions obtained by size exclusion chromatography of biotinylated proteins from the water soluble fraction of a cell lysate. A color-map displaying the results is shown in FIG. 10. The results show that antibodies to the same proteins were grouped together on the basis of complex patterns. This demonstrates the functionality of an automated unbiased method to characterize antibody specificity on the basis of such reactivity patterns. The example also demonstrates that it is possible to select antibodies that are suitable for use in antibody arrays using this technique.

### Example 7

This example relates to the identification of the components of multi-molecular complexes.

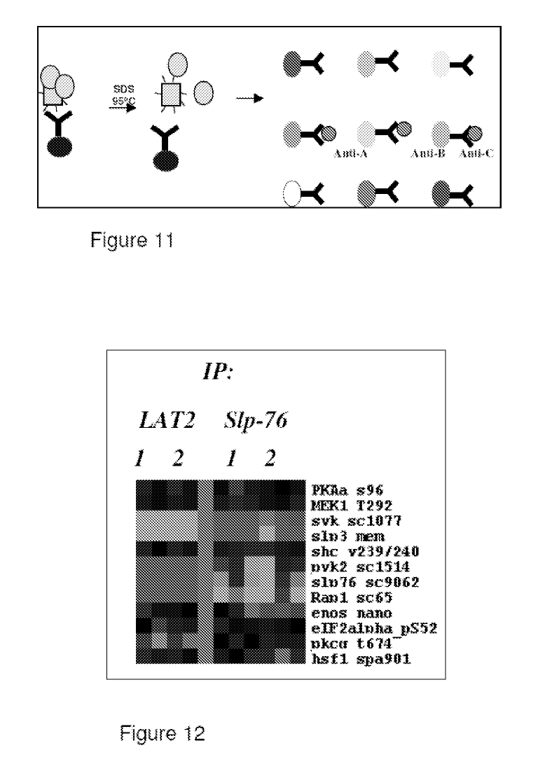

FIG. 11 is a schematic illustration showing immunoprecipitation of a protein complex followed by release of captured protein from particles and incubation of the released proteins with an array. This method allows high throughput detection of proteins in the complex.

Two different antibodies to the adaptor proteins LAT2 and SLP-76 were used to immunoprecipitate these proteins from a high molecular weight form detected by array analysis using the technique described above (see also FIG. 11). The immunoprecipitates were analyzed with particle arrays and the results subjected to cluster analysis. The results were compiled and are shown in FIG. 12. The results show that immunoprecipitates of three antibodies to slp76 precipitate the protein kinase syk, a known interaction partner of slp-76. In contrast, two different antibodies to LAT2 immunoprecipitated protein reactive with antibodies to another protein kinase pyk2, the gtpase rap1 and, surprisingly, a protein reactive with the anti-slp-76 antibody sc9062. The result suggests that the slp-76 antibody sc9062 does not bind slp-76 since it did not capture purified slp-76. The results also suggest that lat2 interacts with pyk2 and Rap1. This can be verified by mass spectrometry. These results represent another application of the principle where the overlapping specificity of immobilized antibodies is detected.

### REFERENCES

1. J. M. Johnson et al., Science 302, 2141 (Dec. 19, 2003).
2. J. F. Rual et al., Nature 437, 1173 (Oct. 20, 2005).
3. S. F. Kingsmore, Nat Rev Drug Discov 5, 310 (April, 2006).
4. G. MacBeath, Nat Genet 32 Suppl, 526 (December, 2002).
5. C. Wingren, C. A. Borrebaeck, Omics 10, 411 (Fall, 2006).
6. S. Mukherjee et al., Nat Genet 36, 1331 (December, 2004).
7. R. B. Jones, A. Gordus, J. A. Krall, G. MacBeath, Nature 439, 168 (Jan. 12, 2006).
8. K. Blank et al., Anal Bioanal Chem 379, 974 (August, 2004).
9. I. Gilbert et al., Proteomics 4, 1417 (May, 2004).
10. B. Schweitzer et al., Nat Biotechnol 20, 359 (April, 2002).
11. E. Schallmeiner et al., Nat Methods 4, 135 (February, 2007).
12. B. B. Haab, Curr Opin Biotechnol 17, 415 (August, 2006).
13. P. Ellmark et al., Mol Cell Proteomics 5, 1638 (September, 2006).
14. G. A. Michaud et al., Nat Biotechnol 21, 1509 (December, 2003).
15. B. B. Haab, M. J. Dunham, P. O. Brown, Genome Biol 2, RESEARCH0004 (2001).
16. C. Wingren, J. Ingvarsson, M. Lindstedt, C. A. Borrebaeck, Nat Biotechnol 21, 223 (March, 2003).
17. E. Soderlind et al., Nat Biotechnol 18, 852 (August, 2000).
18. C. Wingren, J. Ingvarsson, L. Dexlin, D. Szul, C. A. Borrebaeck, Proteomics 7, 3055 (September, 2007).
19. H. Wang et al., Biochem Biophys Res Commun 347, 586 (Sep. 1, 2006).
20. D. Mahony, D. A. Parry, E. Lees, Oncogene 16, 603 (Feb. 5, 1998).
21. G. Yeretssian, M. Lecocq, G. Lebon, H. C. Hurst, V. Sakanyan, Mol Cell Proteomics 4, 605 (May, 2005).
22. S. S. Ivanov et al., Mol Cell Proteomics 3, 788 (August, 2004).
23. J. Ingvarsson, M. Lindstedt, C. A. Borrebaeck, C. Wingren, J Proteome Res 5, 170 (January, 2006).
24. M. B. Eisen, P. T. Spellman, P. O. Brown, D. Botstein, Proc Natl Acad Sci USA 95, 14863 (Dec. 8, 1998).

1. A method of analysing the interaction between a mixture of molecular components and a group of binding agents comprising the steps of:
(i) separating the molecular components in the mixture into a plurality of fractions on the basis of a physical parameter or location;
(ii) providing a plurality of different binding agents,
(iii) contacting the binding agents with at least two of the fractions and detecting the binding of the molecular components to the binding agents in at least two of the fractions; and
(iv) detecting the presence of a plurality of the molecular components by the binding of the molecular components to the binding agents.

2. A method of analysing a mixture of molecular components comprising the steps of:
(i) separating the molecular components in the mixture into a plurality of fractions on the basis of a physical parameter and contacting each fraction with a plurality of reporter molecules;
(ii) providing a plurality of different binding agents,
(iii) contacting the binding agents with at least two of the fractions and detecting the binding of the reporter molecules to the binding agents in at least two of the fractions; and
(iv) detecting the presence of a plurality of the molecular components by the binding of the reporter molecules to the binding agents.

3. A method according to claim 2 wherein the reporter molecules are polypeptides susceptible to enzymatic modification.

4. A method of analysing the interaction between a mixture of molecular components and a group of binding agents comprising the steps of:
(i) producing an enriched fraction of molecular components possessing a combination of two or more physical parameters shared by less than 5% of the molecular components in the mixture
(ii) selecting a plurality of different binding agents having specificity for molecular components having the physical parameters.
(iii) contacting the binding agents with the enriched fraction of molecular components and detecting the binding of the molecular components in the enriched fraction to the binding agents; and
(iv) detecting the presence of a plurality of the molecular components by the binding of the molecular components to the binding agents.

5. A method according to claim 1 wherein the binding agents are immobilised on one or more solid substrates.

6. A method according to claim 5 wherein the binding agents are immobilised in an array on the surface of one planar substrate or a planar substrate comprising three-dimensional surface structures.

7. A method according to claim 5 wherein the binding agents are immobilised on a plurality of particles, each particle having immobilised thereon binding agents specific for the same target molecules.

8. A method according to claim 7 wherein the particles having binding agents specific for one type of target molecule have a different detectable feature from the particles having binding agents specific for another type of target molecule.

9. A method according to claim 8 wherein the detectable feature is fluorescence, size, acoustic properties, charge or magnetic properties.

10. A method according to claim 7 wherein each particle has at least one type of dye molecule bound to it, preferably at least three types of dye molecules bound to it.

11. A method according to claim 10 wherein the or each dye molecule is selected from the following dye molecules: a dye molecule having an absorption maximum of 405 nm and an emission maximum of 420-450 nm; a dye molecule having an absorption maximum of 405 nm and an emission maximum of greater than 500 nm; a dye molecule having an absorption maximum of 488 nm and an emission maximum of 520-530 nm; and a dye molecule having an absorption maximum of 632 nm and an emission maximum of 650-670 nm.

12. A method according to claim 11 wherein the or each molecule is selected from Alexa 488, Alexa 647, Pacific Blue and Pacific Orange.

13. A method according to claim 8 wherein step (iii) comprises the step of using a flow cytometer.

14. A method according to claim 5 wherein the binding agents are immobilised on the substrate via affinity coupling.

15. A method according to claim 14 wherein the affinity coupling is via protein G, protein A, protein L, streptavidin, antibodies or fragments thereof.

16. A method according to claim 14 wherein step (iii) is carried out in a medium which comprises a non-functional binding agent, preferably in a concentration of at least 100 times greater than the concentration of binding agents released from the particles during a 24 h incubation period at 4° C.

17. A method according to claim 16 wherein the non-functional binding agent is non-immune IgG.

18. A method according to claim 1 wherein step (i) comprises separating the molecular components in the mixture into at least three fractions, preferably between 3 and 100 fractions, more preferably between 3 and 50 fractions, more preferably between 10 and 30 fractions.

19. A method according to claim 1 wherein step (i) comprises separation or enrichment of molecular components in the mixture by: sub-cellular fractionation of a cell lysate; differential mass separation; charge separation; hydrophobicity separation; or binding of molecular components to different affinity ligands.

20. A method according to claim 1 wherein step (i) is carried out by size exclusion chromatography, SDS PAGE elution, dialysis, filtration, ion exchange separation, or isoelectric focussing.

21. A method according to claim 1 wherein the binding agents comprise antibodies or antigen-binding fragments thereof, affibodies, polypeptides, peptides, oligonucleotides, T-cell receptors, or MHC molecules

22. A method according to claim 1 further comprising attaching at least one label to a plurality of molecular components in the mixture or to the reporter molecules.

23. A method according to claim 22 wherein the step of attaching the label or labels to the molecular components or reporter molecules is carried out prior to step (i).

24. A method according to claim 22 wherein the step of attaching the label for labels to the plurality of molecular components or reporter molecules is carried out after step (i).

25. A method according to claim 22 wherein the step of attaching the label for labels to the plurality of molecular components is carried out after step (iii).

26. A method according to claim 24 wherein a different label is attached to the molecular components or reporter molecules of each fraction.

27. A method according to claim 22 wherein the label is attached to the plurality of molecular components or reporter molecules via a chemically reactive group.

28. A method according to claim 22 wherein the label is attached to the plurality of molecular components or reporter molecules via, a peptide, a polypeptide, an oligonucleotide, or an enzyme substrate,

29. A method according to claim 22 further comprising carrying out steps (i), (ii) and (iii) in respect of a second mixture of molecular components and further comprising the step of attaching a further label or labels to a plurality of the molecular components of the second mixture of molecular components.

30. A method according to claim 22 wherein the or each label comprises a hapten, fluorescent or luminescent dye or a radioactive or non-radioactive isotope.

31. A method according to claim 1 wherein the binding between a binding agent and a molecular component or receptor molecule is detected by a label free system, preferably, surface plasmon resonance or magnetic resonance.

32. A method according to claim 1 wherein the binding agents form sets, each set of binding agents being capable of binding the same target molecule; the binding agents of at least two sets being capable of binding different target molecules.

33. A method according to claim 32 wherein there are at least three sets of binding agents whose binding agents are capable of binding different target molecules.

34. A method according to claim 32 wherein at least two binding agents in each set are preselected to bind to the same target molecule.

35. A method according to claim 32 wherein at least 40 of the binding agents are capable of binding at least one, preferably at least two, other target molecule in a prokaryotic or eukaryotic cell lysate in addition to the target molecule, directly or indirectly, in an aqueous buffered solution having a pH between 4 and 8.

36. A method according to claim 1 wherein at least two of the fractions are contacted with an overlapping repertoire of binding agents.

37. A method according to claim 1 wherein at least two of the fractions are contacted with a different repertoire of binding agents.

38. A method according to claim 1 and further comprising the step of, prior to step (iii), enriching the mixture or a fraction of the mixture with one species of molecular component.

39. A method according to claim 37 wherein the step of enriching the mixture or fraction comprises: contacting the mixture or fraction with an affinity reagent capable of binding to the species of molecular component; selectively removing the species of molecular component from at least some other components in the mixture or fraction; and releasing the affinity reagent from the species of molecular component.

40. A method according to claim 38 wherein the species of molecular component is a protein complex.

41. A method according to claim 40 further comprising the step of separating the protein complex into its constituent proteins after the enriching step and prior to step (iii).

42. A method according to claim 1 further comprising the step of:
(v) analysing at least some of the molecular components or reporter molecules that have been bound to the binding agents using mass spectrometry.

43. A method according to claim 1 wherein the molecular components comprise proteins.

44. A method of analysing the binding specificity of a plurality of binding agents comprising carrying out the method according to claim 1, wherein step (i) comprises separating the molecular components in the mixture into at least three fractions on the basis of the physical parameter and comparing the binding of the binding agents with respect to at least three of the fractions.

45. A product for analysing a mixture of molecular components wherein the product comprises a plurality of sets of binding agents having the same degree of binding specificity as an antibody, said binding agents having been selected based on their selectivity and capacity for binding molecular components in a sample by means of a protocol comprising the steps of:
(i) separating the molecular components of a biological sample into a plurality of fractions on the basis of a physical parameter or location;
(ii) providing a plurality of different binding agents;
(iii) contacting the binding agents with at least two of the fractions and detecting the binding of the molecular components to the binding agents in at least two of the fractions;
(iv) selecting binding agents where each selected binding agent has a specificity for one molecular component in a fraction of above 80% as measured by a uniform distribution of signal measured across a series of continuous fractions and a binding affinity for said specific molecular component of less than 1 μM under specified binding conditions, wherein the specified binding conditions are in an aqueous buffered solution having a pH of between 4 and 8 and wherein the binding agent is immobilised to a solid substrate under the specified binding conditions.

46. A product for analysing a mixture of molecular components wherein the product comprises: means for producing an enriched fraction of the mixture on the basis of a physical parameter or location of molecular components in the fraction; and a plurality of binding agents, having the same degree of binding specificity as antibodies, and wherein the binding agents have a specificity for one molecular component in the fraction above 80% under specified binding conditions, wherein the specified binding conditions are in an aqueous buffered solution having a pH of between 4 and 8 and wherein the binding agent is immobilised to a solid substrate under the specified binding conditions.

47. A product according to claim 45 wherein the biological sample is selected from blood and blood products including plasma, serum and blood cells; bone marrow, mucus, lymph, ascites fluid, spinal fluid, biliary fluid, saliva, urine, extracts from brain, nerves and neural tracts, muscle, heart, liver, kidney, bladder and urinary tracts, spleen, pancreas, gastric tissue, bowel, biliary tissue, skin, thyroid gland, parathyroid gland, salivary glands, adrenal glands, mammary glands, gastric and intestinal mucosa, lymphatic tissue, mammary glands, adipose tissue, adrenal tissue, ovaries, uterus, blood and lymphatic vessels, endothelium, lung and respiratory tracts, prostate, testes, bone, lysates from cells originating from said organs and lysates from bacteria, and yeast,

48. A product according to claim 45 wherein the binding agents are immobilised on one or more solid substrates.

49. A product according to claim 48 wherein the binding agents are immobilised in an array on the surface of one planar substrate or a planar substrate comprising three-dimensional surface structures.

50. A product according to claim 48 wherein the solid substrates are a plurality of particles, each particle having immobilised thereon binding agents specific for the same target molecules.

51. A product according to claim 50 wherein the particles having binding agents specific for one molecular component have a different detectable feature from the particles having binding agents specific for another molecular component.

52. A product according to claim 51 wherein the detectable feature is fluorescence, size, acoustic properties, charge or magnetic properties.

53. A product according to claim 50 wherein each particle has at least one type of dye molecule bound to it, preferably at least three types of dye molecules bound to it.

54. A product according to claim 53 wherein the or each dye molecule is selected from the following dye molecules: a dye molecule having an absorption maximum of 405 nm and an emission maximum of 420-450 nm; a dye molecule having an absorption maximum of 405 nm and an emission maximum of greater than 500 nm; a dye molecule having an absorption maximum of 488 nm and an emission maximum of 520-530 nm; and a dye molecule having an absorption maximum of 632 nm and an emission maximum of 650-670 nm.

55. A product according to claim 54 wherein the or each molecule is selected from Alexa 488, Alexa 647, Pacific Blue and Pacific Orange.

56. A product according to claim 48 wherein the binding agents are immobilised on the substrate via affinity coupling.

57. A product according to claim 56 wherein the affinity coupling is via protein G, protein A, protein L, streptavidin, binding agents for affinity tags, or nucleotides.

58. A product according to claim 45 wherein the binding agents comprise antibodies or antigen-binding fragments thereof, affibodies, peptides, DNA or RNA fragments, T-cell receptors or MHC molecules.

59. A product according to claim 45 comprising at least 40 sets of binding agents whose binding agents are capable of binding different molecular components.

60. A product according to claim 45 wherein the binding agents have a binding affinity of less than 100 nm under the specified binding conditions.

61. A product according to claim 59 wherein at least 40 sets of the binding agents are capable of binding between 2 and 20 target molecules in a biological sample under the specified binding conditions.

62. A bead comprising a particle having at least three different dye molecules covalently attached thereto, the dye molecules being selected from at least three of the following dye molecules:
(i) a dye molecule having an absorption maximum of 405 nm and an emission maximum of 420-450 nm;
(ii) a dye molecule having an absorption maximum of 405 nm and an emission maximum of greater than 500 nm;
(iii) a dye molecule having an absorption maximum of 488 nm and an emission maximum of 520-530 nm; and
(iv) a dye molecule having an absorption maximum of 632 nm and an emission maximum of 650-670 nm.

63. A bead according to claim 62 wherein the dye molecules are selected from Alexa 488, Alexa 647, Pacific Blue and Pacific Orange.

64. A bead according to claim 62 wherein the bead comprises four of the defined dye molecules.

65. A bead according to claim 62 wherein the three different dye molecules are covalently attached to the particle in different concentrations.

66. A set of beads, each bead in the set being in accordance with claim 62 and wherein at least two of the beads in the set have different concentrations of at least one of the covalently attached dye molecules.

67. A set of beads according to claim 66 wherein each particle has four different dye molecules covalently attached to it and wherein, across the set of beads, there are at least four different concentrations of two of the dye molecules on the surface of the particles; at least three different concentrations of one of the dye molecules on the surface of the particles and at least two different concentrations of the other dye molecule on the surface of the particles.
